(19) United States
(12) Patent Application Publication
(10) Pub. No.: US 2025/0190500 A1
(43) Pub. Date: Jun. 12, 2025

(54) CONTENT SEARCH METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventors: Peng OU, Shenzhen (CN); Wei DU, Shenzhen (CN); Kuankuan JIANG, Shenzhen (CN); Naixin KANG, Shenzhen (CN)

(21) Appl. No.: 19/062,190

(22) Filed: Feb. 25, 2025

Related U.S. Application Data
(63) Continuation of application No. PCT/CN2023/128455, filed on Oct. 31, 2023.

(30) Foreign Application Priority Data
Jan. 19, 2023 (CN) 202310103898.4

(51) Int. Cl. G06F 16/953

(52) U.S. Cl. CPC G06F 16/953

(57) ABSTRACT

A content search method performed by a computer device includes obtaining a search term from a content input area of a first application interface, and displaying a candidate search engine; and switching from the first application interface to a second application interface in response to a selection operation on a target search engine in the candidate search engine. A search result, obtained after a searching process of the search term on the target search engine, is displayed on the second application interface.

### CROSS-REFERENCES TO RELATED APPLICATIONS

This application is a continuation application of PCT Patent Application No. PCT/CN2023/128455, filed on Oct. 31, 2023, which claims priority to Chinese Patent Application No. 2023101038984, filed on Jan. 19, 2023, all of which is incorporated herein by reference in their entirety.

### FIELD OF THE TECHNOLOGY

The present disclosure relates to the field of human-computer interaction and, in particular, to a content search method and apparatus, a computer device, a storage medium, and a computer program product.

### BACKGROUND OF THE DISCLOSURE

When using an application, a user may need to switch to another application for content search. For example, the user may search for a web page after ending a chat, search for a TV series on a video application after browsing a clip of the TV series on a short video application, or search, after browsing a commodity on an e-commerce application, for the same commodity on another e-commerce application.

For performing content searching by switching the application, the user needs to first close a current application, then open a target application for searching, and thus obtain a search result. This process is cumbersome, resulting in low search efficiency.

### SUMMARY

One embodiment of the present disclosure provides a content search method, performed by a computer device. The method includes obtaining a search term from a content input area of a first application interface, and displaying a candidate search engine; and switching from the first application interface to a second application interface in response to a selection operation on a target search engine in the candidate search engine. A search result, obtained after a searching process of the search term on the target search engine, is displayed on the second application interface.

Another embodiment of the present disclosure provides a computer device. The computer device includes one or more processors and a memory containing a computer program that, when being executed, causes the one or more processors to perform: obtaining a search term from a content input area of a first application interface, and displaying a candidate search engine; and switching from the first application interface to a second application interface in response to a selection operation on a target search engine in the candidate search engine. A search result, obtained after a searching process of the search term on the target search engine, is displayed on the second application interface.

Another embodiment of the present disclosure provides a non-transitory computer-readable storage medium containing a computer program that, when being executed, causes at least one processor to perform: obtaining a search term from a content input area of a first application interface, and displaying a candidate search engine; and switching from the first application interface to a second application interface in response to a selection operation on a target search engine in the candidate search engine. A search result, obtained after a searching process of the search term on the target search engine, is displayed on the second application interface.

### BRIEF DESCRIPTION OF THE DRAWINGS

FIG. 1 is a structural block diagram of a computer system according to an embodiment of the present disclosure.

FIG. 2 is a schematic diagram of a content search method according to an embodiment of the present disclosure.

FIG. 3 is a flowchart of a content search method according to an embodiment of the present disclosure.

FIG. 4 is a flowchart of a content search method according to an embodiment of the present disclosure.

FIG. 5 is a schematic diagram of a search engine list according to an embodiment of the present disclosure.

FIG. 6 is a flowchart of a content search method according to an embodiment of the present disclosure.

FIG. 7 is a schematic diagram of a content search method according to an embodiment of the present disclosure.

FIG. 8 is a flowchart of a content search method according to an embodiment of the present disclosure.

FIG. 9 is a flowchart of a content search method according to an embodiment of the present disclosure.

FIG. 10 is a schematic diagram of a content search method according to an embodiment of the present disclosure.

FIG. 11 is a structural block diagram of a content search apparatus according to an embodiment of the present disclosure.

FIG. 12 is a structural block diagram of a computer device according to an embodiment of the present disclosure.

### DESCRIPTION OF EMBODIMENTS

To make the objectives, technical solutions, and advantages of the present disclosure clearer, implementations of the present disclosure are further described below in detail with reference to the accompanying drawings.

Exemplary embodiments are described in detail herein, and examples of the exemplary embodiments are shown in the accompanying drawings. When the following descriptions are made with reference to the accompanying drawings, unless otherwise indicated, the same numbers in different accompanying drawings represent the same or similar elements. The following implementations described in the following exemplary embodiments do not represent all implementations that are consistent with the present disclosure. On the contrary, the implementations are merely examples of apparatuses and methods that are described in detail in the appended claims and that are consistent with some aspects of the present disclosure.

The terms used in the present disclosure are merely for the purpose of illustrating specific embodiments, and are not intended to limit the present disclosure. The terms “a”, “said” and “the” of singular forms used in the present disclosure and the appended claims are also intended to include plural forms, unless otherwise specified in the context clearly. The term “and/or” used in this specification indicates and includes any or all possible combinations of one or more associated listed items.

In the present disclosure, before and during acquisition of relevant data of the user (for example, a search term), a prompt interface or a pop-up window may be displayed, or speech prompt information may be outputted. The prompt interface, the pop-up window, or the speech prompt information is configured for prompting the user that relevant data of the user is currently being acquired. In this way, in the present disclosure, only after a confirmation operation performed by the user on the prompt interface or the pop-up window is obtained, the relevant steps of obtaining the relevant data of the user start to be performed. Otherwise (in other words, when the confirmation operation performed by the user on the prompt interface or the pop-up window is not obtained), the relevant steps of obtaining the relevant data of the user are ended, that is, the relevant data of the user is not obtained. In other words, all user data acquired in the present disclosure is acquired with user consent and authorization, and acquisition, use, and processing of relevant user data need to comply with relevant laws, regulations, and standards of relevant countries and regions.

Although terms “first”, “second”, and the like may be used in the present disclosure to describe various pieces of information, these pieces of information are not limited by the terms. These terms are merely used to differentiate the same type of information. For example, without departing from the scope of the present disclosure, a first parameter may also be referred to as a second parameter, and similarly, a second parameter may also be referred to as a first parameter. Depending on the context, for example, a word “if” used herein may be explained as “while . . . ” or “when . . . ” or “in response to determining”.

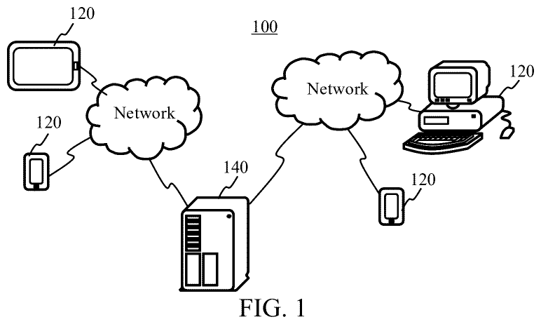

FIG. 1 is a structural block diagram of a computer system according to an exemplary embodiment of the present disclosure. The computer system may be implemented as a system architecture of a content search method. A computer system 100 includes a terminal 120 and a server 140.

The terminal 120 may be an electronic device such as a mobile phone, a tablet computer, an in-vehicle terminal (car machine), a wearable device, a personal computer (PC), or a self-booking terminal. A client running a target application may be installed on the terminal 120. The target application may be an input method program; or an application configured to perform searching, for example, a search engine; or another application that provides a search function and an application switching function. This is not limited in the present disclosure. In addition, a form of the target application is not limited in the present disclosure. The target application includes, but not limited to, an application (App) installed on the terminal 120, an applet, or the like, and may also be in a form of a web page.

The server 140 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The server 140 may be a back-end server of the target application, to provide a back-end service for the client of the target application.

In some embodiments, the server may alternatively be implemented as a node in a blockchain system.

The terminal 120 may communicate with the server 140 through a network, such as a wired network or a wireless network.

In the content search method provided in this embodiment of the present disclosure, operations may be performed by a computer device. The computer device is an electronic device having data calculation, processing, and storage capabilities. By using an implementation environment of the solution shown in FIG. 1 as an example, the terminal 120 may perform the content search method (for example, the client running the target application installed on the terminal 120 performs the content search method), the server 140 may perform the content search method, or the terminal 120 and the server 140 cooperate to perform the content search method. This is not limited in the present disclosure.

A person skilled in the art may learn that there may be more or fewer terminals 120. For example, there may be only one terminal 120, or there may be dozens of or hundreds of terminals 120 or more. The quantity and the device type of the terminals are not limited in the embodiments of the present disclosure.

In the related art, an application on a terminal only provides content retrieval based on the application, which intercepts content of another application. In this way, when searching for same content, a user usually needs to open a plurality of applications to obtain a search result, causing much inconvenience. For example, if the user is using an e-commerce application A, the user can only obtain a search result for a commodity on the e-commerce application A; and the user needs to first close the e-commerce application A, start an e-commerce application B, and input a commodity search term, to obtain a search result for the same commodity on the e-commerce application B. The operations are cumbersome. According to the method provided in this embodiment, operations can be effectively simplified, thereby implementing content searching.

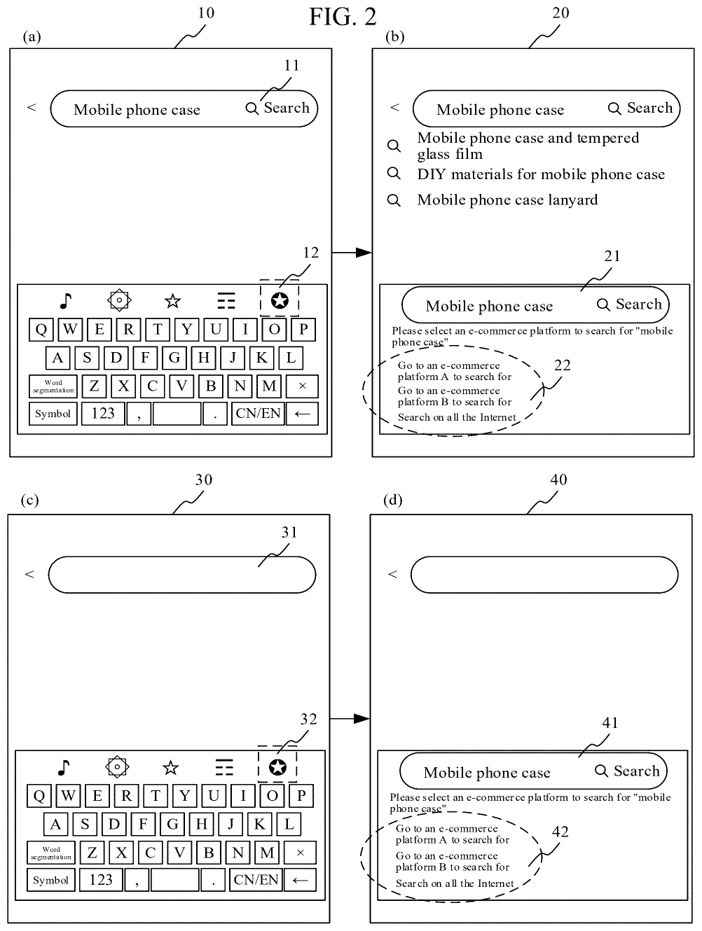

FIG. 2 is a schematic diagram of a content search method according to an exemplary embodiment of the present disclosure. An example in which a terminal performs the content search method is used for description. The method in this embodiment is mainly implemented based on an input method program. The input method program is installed on the terminal. The input method program is an application configured to support an input method. The input method is an encoding method used to input various symbols and text into the terminal. Various applications (Apps) configured to perform searching are further installed on the terminal, for example, a video App configured to search for videos, an e-commerce App configured to search for commodities, and a browser App configured to search for various web pages. The input method program in this embodiment mainly implements functions of obtaining a search term, providing a search engine list, and transmitting the search term to different applications.

This embodiment mainly relates to an application scenario of performing content searching by switching an application, for example, searching for a web page after ending a chat (switching from a chat App to a browser App for searching), searching for a TV series on a video App after browsing a clip of the TV series on a short video App (switching from the short video App to a long video App for searching), or searching, after browsing a commodity on one e-commerce App, for the same commodity on another e-commerce App (switching from the one e-commerce App to the another e-commerce App for searching). The content search method provided in this embodiment may include the following operations.
1. Display an input method program based on a content input area of a first application interface.

A user starts a first application by using a terminal, and the terminal displays the first application interface in response to the start operation on the first application. The content input area is displayed on the first application interface, and the content input area is an area configured for providing input of a search term. The user starts the input method program by clicking on the content input area of the first application interface. The terminal displays the input method program based on the content input area of the first application interface.

In an actual application, the content input area may be presented in a form of an input box; and the search term may be in a text form. The search term may be a word, a statement, or the like. A content length of the search term is not limited in the embodiments of the present disclosure.
2. Display a search engine list in response to that the input method program obtains the search term from the content input area of the first application interface, the search engine list including a candidate search engine.

In some embodiments, the input method program provides a search function control, and the user enables a content search function provided in this embodiment by clicking on the search function control. In response to that the input method program obtains the search term (Query) from the content input area of the first application interface, the terminal displays the search engine list provided by the input method program, the search engine list including the candidate search engine.

### Automatically Obtain a Search Term

When the content input area of the first application interface is a search box and a search term exists in the search box, the search function control is clicked on, the input method program automatically obtains the search term, and the terminal displays the search engine list.

For example, as shown in Part (a) in FIG. 2, a content input area 11 is displayed on a first application interface 10, and the input method program provides a search function control 12. By using an example in which the first application is an “e-commerce application X”, when the content input area 11 of the first application interface 10 is a search box and a search term “mobile phone case” exists in the search box, as shown in Part (b) in FIG. 2, the input method program automatically obtains the search term “mobile phone case” on a first application interface 20, displays the search term “mobile phone case” in a search box 21 of the input method program, and displays a search engine list 22. The search engine list 22 includes candidate search engines: an e-commerce platform A, an e-commerce platform B, and all e-commerce platforms on the Internet.

### Manually Input a Search Term

When the content input area of the first application interface is not a search box, or the content input area of the first application interface is a search box but no search term exists in the search box, the search function control is clicked on, the input method program provides the search box, a search term is inputted into the search box provided by the input method program, the input method program obtains the search term, and the terminal displays the search engine list.

For example, as shown in Part (c) in FIG. 2, a content input area 31 is displayed on a first application interface 30, and the input method program provides an intelligent search control 32. By using an example in which the first application is an e-commerce application, when the content input area 31 of the first application interface 30 is not a search box, or the content input area 31 is a search box but no search term exists, as shown in Part (d) in FIG. 2, the input method program displays a search box 41 on a first application interface 40, the user inputs a search term “mobile phone case” into the search box 41, the input method program obtains the search term “mobile phone case”, and displays a search engine list 42. The search engine list 42 includes candidate search engines: an e-commerce platform A, an e-commerce platform B, and all e-commerce platforms on the Internet.
3. Switch from the first application interface to a second application interface in response to a selection operation on a target search engine in the candidate search engine, a search result obtained after a searching process of the search term on the target search engine being displayed on the second application interface; and the first application interface and the second application interface being interfaces of different applications.

The terminal switches from the first application interface to the second application interface in response to the selection operation on the target search engine in the candidate search engine, where the search result on the second application interface is provided by the target search engine.

For example, as shown in Part (b) in FIG. 2, the user selects a target search engine “e-commerce platform A” from the candidate search engines: the e-commerce platform A, the e-commerce platform B, and all the e-commerce platforms on the Internet; the terminal transmits the search term “mobile phone case” to the “e-commerce platform A” through the input method program; and the terminal switches from the first application interface corresponding to the “e-commerce application X” to the second application interface corresponding to the “e-commerce platform A”. A search result obtained after a searching process of the search term “mobile phone case” on the target search engine “e-commerce platform A” is displayed on the second application interface. The first application interface and the second application interface are interfaces of different e-commerce applications.

In conclusion, according to the content search method provided in this embodiment of the present disclosure, an input method program is displayed based on a content input area of a first application interface; a search engine list is displayed in response to that the input method program obtains a search term from the content input area of the first application interface, the search engine list including a candidate search engine; and switching is performed from the first application interface to a second application interface in response to a selection operation on a target search engine in the candidate search engine, a search result obtained after a searching process of the search term on the target search engine being displayed on the second application interface; and the first application interface and the second application interface being interfaces of different applications. In the related art, when a user performs searching by switching an application, the user needs to first close a currently used first application, then start a second application that the user intends to use, and input a search term into the second application again, to obtain a search result. Compared with the related art, through use of the foregoing method provided in this embodiment, the candidate search engine for the user to select may be directly displayed after the search term is obtained. Therefore, when the user performs searching by switching the application, the user does not need to close the currently used first application, may directly select the candidate search engine to implement switching of the application, and also does not need to repeatedly input the search term into the second application; and after the user selects the target search engine, the search result obtained through searching on the target search engine may be directly displayed on the second application interface. In this way, operations are reduced, the second application interface can be directly switched to, and the search result can be displayed, so that efficiency of performing searching by switching the application is effectively improved, and operations are more convenient. In addition, the user can find expected content, service, commodity, and the like more quickly, and user experience can further be effectively improved.

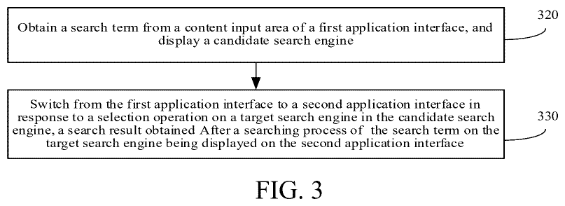

FIG. 3 is a flowchart of a content search method according to an embodiment of the present disclosure. An example in which the method is applied to the terminal 120 or the target application installed on the terminal 120 shown in FIG. 1 is used for description. The method includes the following operations.

Operation 320: Obtain a search term from a content input area of a first application interface, and display a candidate search engine.

The first application is an application started or being used by a user at a current moment, and the first application may also be referred to as a current application. The first application interface is an interface of a first application.

In some embodiments, before displaying the candidate search engine, the terminal may also first display the first application interface. For example, the terminal displays the first application interface in response to a start operation on the first application (such as a trigger operation (such as a click operation or a double-click operation) on an icon of the first application).

For example, the first application may be a browser or another application. For example, if the user is browsing a web page through a browser, the first application is the browser, and the first application interface is a browser interface on which the web page is displayed. Alternatively, if the user is browsing a commodity on an e-commerce application A, the first application is the e-commerce application A, and the first application interface is a page on which commodity information such as a picture, a name, a shop, and a price of the commodity is displayed.

The content input area may be an area that is displayed on the first application interface and that is configured for providing the search term. In an actual application, the content input area may be presented in a form of an input box.

In some embodiments, the content input area includes a search box and a non-search box. The search box is an area in which a search term can be searched for and a search result can be displayed after the search term is inputted, and the search box usually carries a search button. When the user inputs the search term into the search box, the user clicks on the search button to search for the inputted search term. The non-search box is an area in which a search term can be inputted or a search term can be displayed, but the search term cannot be searched for.

In some embodiments, if the content input area may be provided by the first application, the content input area is one of a search box and a non-search box; or if the content input area may be provided by an input method program, the content input area is a search box.

The input method program is an application configured to support an input method. The input method is an encoding method used to input various symbols and text into the terminal.

The input method program is installed on the terminal. The terminal displays the input method program based on the content input area of the first application interface. In an embodiment, the user starts the input method program by clicking on the content input area of the first application interface; and the terminal displays the input method program in response to a click operation on the content input area of the first application interface.

In some embodiments, the input method program is displayed with one of the following types: a pinyin 9-key type, a pinyin 26-key type, a handwriting type, a five-stroke type, a stroke type, or a voice input type. The input method program is displayed below a display screen of the terminal, and a display area of the input method program may occupy half or less of the display screen.

In an actual application, the terminal displays at least one candidate search engine. For example, when the terminal displays a plurality of (that is, at least two) candidate search engines, the plurality of candidate search engines may be different search engines.

In some embodiments, the candidate search engine displayed by the terminal may be carried in a search engine list. In other words, the terminal displays the search engine list, the search engine list including the candidate search engine. The search engine list is a list configured for displaying the at least one candidate search engine. The candidate search engine is at least one search engine provided for the user to select. The search engine list may also be referred to as a quick search jump entry.

In some embodiments, the search engine list is provided by the input method program of the terminal, and is displayed in the display area corresponding to the input method program of the first application interface of the terminal. A size of a display area corresponding to the search engine list is equal to or larger than a size of the display area corresponding to the input method program.

In some embodiments, the input method program obtains the search term from the content input area of the first application interface, where the search term may be automatically obtained, or may be manually inputted by the user.

For example, when the content input area of the first application interface is a search box, and a search term exists in the search box, the input method program automatically obtains the search term. When the content input area of the first application interface is a search box but no search term exists in the search box, or the content input area is not displayed on the first application interface, the input method program obtains a search term manually inputted by the user.

In some embodiments, the input method program includes an intelligent search control. Correspondingly, the terminal may obtain the search term from the content input area of the first application interface in the following manner: obtaining, in response to a trigger operation on the intelligent search control, the search term from the content input area of the first application interface if the content input area includes the search term.

An operation form of the trigger operation mentioned in this embodiment of the present disclosure is not limited, and the trigger operation may be any operation that can trigger a related instruction, such as a click operation, a double-click operation, or a slide operation.

In some embodiments, the input method program includes an intelligent search control. Correspondingly, the terminal may also obtain the search term from the content input area of the first application interface in the following manner: displaying, in response to a trigger operation on the intelligent search control, a second content input area if the first content input area does not include the search term; and obtaining an inputted search term from the second content input area in response to the search term input operation in the second content input area.

In some embodiments, the input method program includes an intelligent search control. Correspondingly, the terminal may also obtain the search term from the content input area of the first application interface in the following manner: displaying the content input area on the first application interface in response to a trigger operation on the intelligent search control; and obtaining an inputted search term from the content input area in response to a search term input operation in a second content input area.

In some embodiments, in response to that the input method program obtains the search term from the content input area of the first application interface, the terminal displays the search engine list based on information about the search engine list provided by the input method program.

For example, the information about the search engine list includes a search term prompt statement and search engine information of each candidate search engine in the search engine list, where the search engine information includes at least one of a name, an icon, or a display order of the search engine.

In some embodiments, the search term prompt statement may be represented as: Please select different search engines to search for the search term. For example, if the search term is a “mobile phone case”, the search term prompt statement is represented as: Please select different e-commerce search engines to search for the “mobile phone case”.

For example, the search term prompt statement may be displayed at the top of the display area of the search engine list, and each candidate search engine is displayed below the search term prompt statement. Referring to a search engine list 42 in Part (d) in FIG. 2, a search term prompt statement is displayed at the top of the search engine list 42: Please select an e-commerce platform to search for a “mobile phone case”; and a plurality of candidate search engines: an e-commerce platform A, an e-commerce platform B, and all e-commerce platforms on the Internet are displayed below the search term prompt statement.

In some embodiments, the candidate search engines in the search engine list are different search engines. For example, the different candidate search engines include search engines of different sources, search engines in different fields, or search engines of different sources and search engines in different fields.

The search engines of different sources may also be referred to as actual search engines. The search engines of different sources include search engines corresponding to different websites or different applications. For example, a video application A (or a video website A), a video application B (or a video website B), a video application C (or a video website C), an e-commerce application A (or an e-commerce website A), an e-commerce application B (or an e-commerce website B), and an e-commerce application C (or an e-commerce website C) are search engines of different sources. The video application A, the video application B, and the video application C may also be referred to as search engines of different sources in a same vertical field, where the vertical field is a video field.

The search engines in different fields may also be referred to as type search engines. For example, a web page search engine, an e-commerce search engine, a video search engine, a music search engine, and a takeout search engine are search engines in different fields.

In some embodiments, a quantity of candidate search engines in the search engine list is limited. The quantity may be a preset quantity, or the quantity may be determined based on a type of the first application, or the quantity may be determined based on application usage of the user.

For example, if the first application is a video application, the search engine list includes three candidate search engines; or if the first application is an e-commerce application, the search engine list includes five candidate search engines.

For example, the user often uses an e-commerce application, but does not often use a takeout application. In this case, a first quantity of candidate search engines in the search engine list when the first application is the e-commerce application is greater than a second quantity of candidate search engines in the search engine list when the first application is the takeout application.

In some embodiments, the candidate search engine in the search engine list is associated with the first application rather than a part of speech or word meaning of the search term. For example, when the first application is preset as an e-commerce application, the candidate search engine in the search engine list is also an e-commerce application. In this case, regardless of whether the search term is a commodity name or a TV series name, the displayed candidate search engine is the e-commerce application.

Operation 330: Switch from the first application interface to a second application interface in response to a selection operation on a target search engine in the candidate search engine, a search result obtained after a searching process of the search term on the target search engine being displayed on the second application interface.

In some embodiments, the first application interface and the second application interface are interfaces of different applications.

The target search engine is a search engine selected from the candidate search engine.

A second application is another application to which the user intends to switch, and the second application may also be referred to as a target application. The second application interface is an interface of the second application.

For example, the second application may be a browser or another application, and the first application and the second application are different applications. The second application does not include the input method program, but is invoked by the input method program.

For example, if the user is browsing a commodity on an e-commerce application A, the first application is the e-commerce application A, and the first application interface is a page on which commodity information such as a picture, a name, a shop, and a price of the commodity is displayed. When the target search engine selected by the user is an e-commerce application B, the second application is the e-commerce application B, and the terminal starts the e-commerce application B through the input method program, to display the second application interface. Alternatively, when the e-commerce application B is not installed on the terminal, the second application is a browser, and the terminal starts the browser through the input method program and opens a website of the e-commerce application B, to display the second application interface.

The selection operation on the target search engine includes an operation of clicking on the target search engine.

For example, the terminal switches from the first application interface to the second application interface in response to the selection operation on the target search engine in the candidate search engine, the search result obtained after a searching process of the search term on the target search engine being displayed on the second application interface.

For example, when the terminal transmits the search term to the second application through the input method program, the second application obtains the search term, without inputting the search term again by the user, so that the target search engine corresponding to the second application may search for the search term, to obtain the search result. In other words, the search result for the search term is provided by the target search engine.

For example, the e-commerce application A and the e-commerce application B are installed on the terminal. In the related art, the e-commerce application A and the e-commerce application B provide content retrieval based on the e-commerce application A and the e-commerce application B, which intercept content of other applications. In this way, when the user searches for a same commodity, the user needs to open the e-commerce application A to obtain a search result for the commodity on the e-commerce application A, or open the e-commerce application B to obtain a search result for the commodity on the e-commerce application B. In this case, the two applications need to be separately opened, and a search term corresponding to the commodity needs to be inputted into the e-commerce application A and the e-commerce application B separately, to obtain the search results. However, in this embodiment, when the user is browsing a “mobile phone case” on the e-commerce application A, the first application is the e-commerce application A, and the target search engine is the e-commerce platform B. In other words, the second application is the e-commerce application B. After the user searches for the search term “mobile phone case” on the e-commerce application A and performs application switching, the terminal starts the e-commerce application B through the input method program, and transmits the “mobile phone case” to the e-commerce application B; and the terminal switches from an interface of the e-commerce application A to an interface of the e-commerce application B, where a search result obtained after a searching process of the search term “mobile phone case” on the e-commerce application B is displayed on the interface of the e-commerce application B.

In conclusion, according to the content search method provided in this embodiment of the present disclosure, an input method program is displayed based on a content input area of a first application interface; a search engine list is displayed in response to that the input method program obtains a search term from the content input area of the first application interface, the search engine list including a candidate search engine; and switching is performed from the first application interface to a second application interface in response to a selection operation on a target search engine in the candidate search engine, a search result obtained after a searching process of the search term on the target search engine being displayed on the second application interface; and the first application interface and the second application interface being interfaces of different applications. Through use of the foregoing method provided in this embodiment, the candidate search engine for a user to select may be directly displayed after the search term is obtained. Therefore, when the user performs searching by switching an application, the user does not need to close a currently used first application, may directly select the candidate search engine to implement switching of the application, and also does not need to repeatedly input the search term into a second application; and after the user selects the target search engine, the search result obtained through searching on the target search engine may be directly displayed on the second application interface. In this way, operations are reduced, the second application interface can be directly switched to, and the search result can be displayed, so that efficiency of performing searching by switching the application is effectively improved, and operations are more convenient. In addition, the user can find expected content, service, commodity, and the like more quickly, and user experience can further be effectively improved.

In some embodiments, the candidate search engines in the search engine list are different search engines. The different candidate search engines include search engines of different sources, in other words, the terminal displays the search engines of different sources.

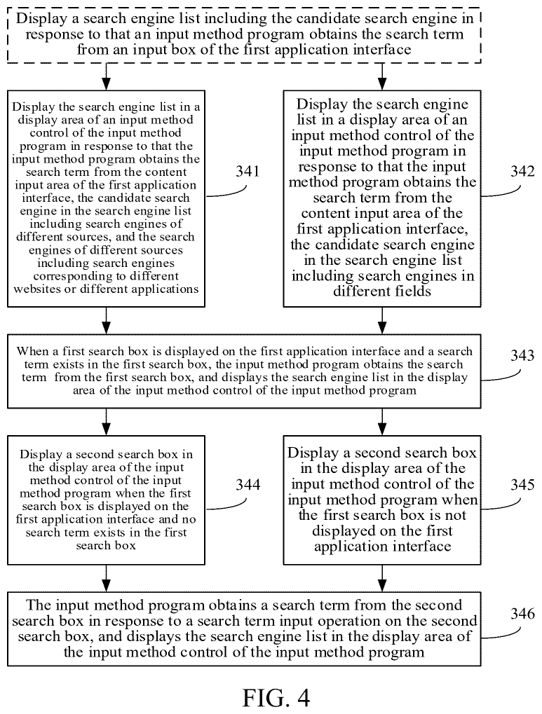

FIG. 4 is a flowchart of a content search method according to an embodiment of the present disclosure. Based on that the candidate search engines include search engines of different sources, the foregoing process of displaying the search engine list including the candidate search engine in response to that the input method program obtains the search term from the input box of the first application interface may be implemented as the following operation.

Operation 341: Display the search engine list in a display area of an input method control of the input method program in response to that the input method program obtains the search term from the content input area of the first application interface, the candidate search engines in the search engine list including search engines of different sources, and the search engines of different sources including search engines corresponding to different websites or different applications.

The input method control is a control that corresponds to the input method program and that is provided for input by the user, and the input method control includes a keyboard. In some embodiments, the keyboard may be one of a pinyin 9-key keyboard, a pinyin 26-key keyboard, a handwriting keyboard, a five-stroke keyboard, a stroke keyboard, a voice input keyboard, or the like.

The display area of the input method control is a display area corresponding to the keyboard, and the content input area may be the input box.

The search engine list is displayed in the display area of the input method control, and the size of the display area corresponding to the search engine list is equal to or larger than a size of the display area corresponding to the input method control.

For example, the terminal displays the search engine list in the display area of the input method control of the input method program in response to that the input method program obtains the search term from the content input area of the first application interface, the candidate search engines in the search engine list including the search engines of different sources, and the search engines of different sources including the search engines corresponding to different websites or different applications.

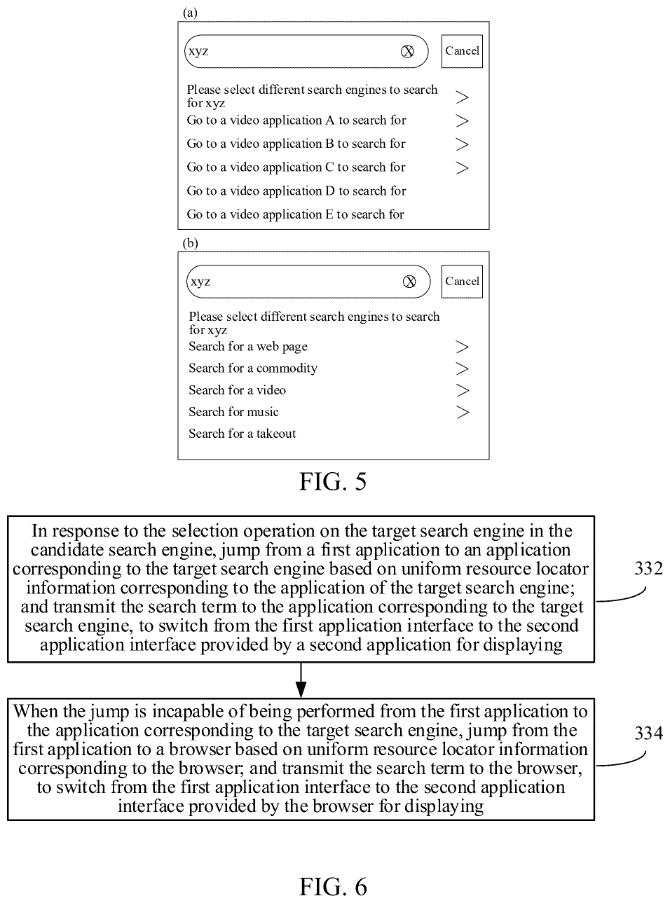

For example, FIG. 5 is a schematic diagram of a search engine list according to an exemplary embodiment of the present disclosure. As shown in Part (a) in FIG. 5, the search term is “xyz”, and the candidate search engines in the search engine list are search engines of different sources, including: a video application A, a video application B, a video application C, a video application D, and a video application E.

In some embodiments, the candidate search engines in the search engine list are different search engines. The different candidate search engines include search engines in different fields, and the terminal displays the search engines in different fields.

Still referring to FIG. 4, based on that the candidate search engines include search engines in different fields, the displaying the search engine list may also be implemented as the following operation.

Operation 342: Display the search engine list in a display area of an input method control of the input method program in response to that the input method program obtains the search term from the content input area of the first application interface, the candidate search engines in the search engine list including search engines in different fields.

The input method control is a control that corresponds to the input method program and that is provided for input by the user, and the input method control includes a keyboard. In some embodiments, the keyboard may be one of a pinyin 9-key keyboard, a pinyin 26-key keyboard, a handwriting keyboard, a five-stroke keyboard, a stroke keyboard, a voice input keyboard, or the like.

The display area of the input method control is a display area corresponding to the keyboard.

The search engine list is displayed in the display area of the input method control, and the size of the display area corresponding to the search engine list is equal to or larger than a size of the display area corresponding to the input method control.

For example, the terminal displays the search engine list in the display area of the input method control of the input method program in response to that the input method program obtains the search term from the content input area of the first application interface, the candidate search engine in the search engine list including the search engines in different fields.

For example, FIG. 5 is a schematic diagram of a search engine list according to an exemplary embodiment of the present disclosure. As shown in Part (b) in FIG. 5, the search term is “xyz”, and the candidate search engines in the search engine list are search engines in different fields, or are referred to as type search engines, including: a web page search engine, an e-commerce search engine, a video search engine, music search engine, and a takeout search engine.

In the related art, the user needs to first close a currently used application, then find, in a plurality of applications of the terminal, a target application that the user intends to use, and then start the target application. Compared with the related art, in the foregoing embodiment, different candidate search engines are displayed in the search engine list for the user to select, so that the user can select the target search engine that the user intends to switch to, without closing the currently opened first application interface, thereby simplifying operations, and improving efficiency of switching the application.

In some embodiments, the input method program of the terminal needs to first obtain the search term, and then trigger to display the search engine list. In one embodiment, the input method program of the terminal automatically obtains a search term.

Still referring to FIG. 4, operation 341 and operation 342 further include operation 343.

Operation 343: When a first search box is displayed on the first application interface and a search term exists in the first search box, the input method program obtains the search term from the first search box, and displays the search engine list in the display area of the input method control of the input method program.

The first search box is a search box provided by the first application. The content input area of the first application interface includes the first search box provided by the first application, as shown in a content input area 11 in Part (a) in FIG. 2.

For example, when the first search box is displayed on the first application interface and the search term exists in the first search box, the input method program obtains the search term from the first search box, and displays the search engine list in the display area of the input method control of the input method program.

In an actual application, the input method program includes an intelligent search control. When the first search box is displayed on the first application interface and the search term exists in the first search box, the input method program obtains the search term from the first search box in response to a trigger operation performed by the user on the intelligent search control. For example, when the user clicks on the intelligent search control in the input method program, the input method program obtains the search term from the first search box in response to the click operation of the user when the search term exists in the first search box.

The intelligent search control mentioned in this embodiment of the present disclosure may also be referred to as an intelligent search button or an intelligent search icon, and a presentation form is not limited in the embodiments of the present disclosure.

In this embodiment, the input method program of the terminal may automatically obtain the search term. In this way, when the user has inputted the search term into the first application, the user does not need to input the search term into the first application again, thereby simplifying operations, implementing automatic obtaining, and improving search efficiency.

In some embodiments, the input method program of the terminal needs to first obtain the search term, and then trigger to display the search engine list. In one embodiment, the input method program of the terminal obtains a search term inputted by the user.

Still referring to FIG. 4, in one embodiment, the method further includes operation 344 and operation 346.

Operation 344: Display a second search box in the display area of the input method control of the input method program when the first search box is displayed on the first application interface and no search term exists in the first search box.

The second search box is a search box provided by the input method program. The content input area of the first application interface includes the second search box provided by the input method program, as shown in a content input area 41 in Part (d) in FIG. 2.

The second search box is displayed in the display area of the input method control of the input method program. For example, the second search box may be displayed at the top of the display area of the entire input method control.

For example, the second search box is displayed in the display area of the input method control of the input method program when the first search box is displayed on the first application interface and no search term exists in the first search box.

Operation 346: The input method program obtains a search term from the second search box in response to a search term input operation on the second search box, and displays the search engine list in the display area of the input method control of the input method program.

The search term input operation is an operation that the user inputs the search term through the input method control.

For example, the input method program of the terminal obtains the search term from the second search box in response to the search term input operation on the second search box, and displays the search engine list in the display area of the input method control of the input method program.

After the second search box is displayed, if the user does not perform the search term input operation on the second search box, but performs a search term input operation on the first search box, it represents that the user expects to continuously use the first application to search for the search term rather than trigger content searching.

In some embodiments, the input method program of the terminal needs to first obtain the search term, and then trigger to display the search engine list. In one embodiment, the input method program of the terminal obtains a search term inputted by the user.

Still referring to FIG. 4, in one embodiment, the method further includes operation 345 and operation 346.

Operation 345: Display a second search box in the display area of the input method control of the input method program when the first search box is not displayed on the first application interface.

The second search box is a search box provided by the input method program. The content input area of the first application interface includes the second search box provided by the input method program, as shown in a content input area 41 in Part (d) in FIG. 2.

The second search box is displayed in the display area of the input method control of the input method program. For example, the second search box may be displayed at the top of the display area of the entire input method control.

For example, the second search box is displayed in the display area of the input method control of the input method program when the first search box is not displayed on the first application interface.

Operation 346: The input method program obtains a search term from the second search box in response to a search term input operation on the second search box, and displays the search engine list in the display area of the input method control of the input method program.

The search term input operation is an operation that the user inputs the search term through the input method control.

For example, the input method program of the terminal obtains the search term from the second search box in response to the search term input operation on the second search box, and displays the search engine list in the display area of the input method control of the input method program.

After the second search box is displayed, if the user does not perform the search term input operation on the second search box, but performs a search term input operation on the first search box, it represents that the user expects to continuously use the first application to search for the search term rather than trigger content searching.

In the foregoing embodiment, the input method program of the terminal may provide an area for the user to input a search term, and obtain the search term after the user inputs the search term, to display the search engine list, thereby improving accuracy of the obtained search term.

In some embodiments, a search engine has a corresponding application, and the application may be installed on the terminal. For example, an e-commerce platform A is a search engine, the e-commerce platform A has a corresponding e-commerce application A, and the e-commerce application A may be installed on the terminal, so that the user may open the e-commerce application A to search for and purchase a commodity.

For example, the second application includes an application corresponding to the target search engine. FIG. 6 is a schematic diagram of a content search method according to an exemplary embodiment of the present disclosure. In one embodiment, operation 330 includes operation 332.

Operation 332: In response to the selection operation on the target search engine in the candidate search engine, jump from the first application to the application corresponding to the target search engine based on uniform resource locator information corresponding to the application of the target search engine; and transmit the search term to the application corresponding to the target search engine, to switch from the first application interface to the second application interface provided by the second application for displaying.

The uniform resource locator (URL) information corresponding to the application of the target search engine is configured for indicating the search result obtained after a searching process of the search term on the target search engine, and the uniform resource locator information corresponding to the application of the target search engine is a URL Scheme.

In some embodiments, the input method program of the terminal can jump from the first application to the application corresponding to the target search engine based on the uniform resource locator information URL Scheme corresponding to the application of the target search engine.

For example, in response to the selection operation on the target search engine in the candidate search engine, the input method program of the terminal jumps from the first application to the application corresponding to the target search engine based on the uniform resource locator information corresponding to the application of the target search engine; and transmits the search term to the application corresponding to the target search engine, to switch from the first application interface to the second application interface provided by the second application for displaying.

Based on this, the application corresponding to the target search engine may obtain the search term, so that the search result obtained after a searching process of the search term on the target search engine is displayed on the second application interface.

In some embodiments, a search engine has a corresponding application, and generally, the search engine further has a corresponding website. When the application corresponding to the search engine is not installed on the terminal, the user may open, through a browser on the terminal, the website of the search engine for searching. For example, an e-commerce platform A is a search engine, and the e-commerce platform A has a corresponding e-commerce application A. When the e-commerce application A is not installed on the terminal, the user may open a website A of the e-commerce platform A through the browser on the terminal to search for and purchase a commodity.

For example, the second application includes a browser. Still referring to FIG. 6, in one embodiment, operation 330 further includes operation 334.

Operation 334: When the jump is incapable of being performed from the first application to the application corresponding to the target search engine, jump from the first application to the browser based on uniform resource locator information corresponding to the browser; and transmit the search term to the browser, to switch from the first application interface to the second application interface provided by the browser for displaying.

The uniform resource locator information corresponding to the browser is configured for indicating the search result obtained after a searching process of the search term on the website of the target search engine, and the uniform resource locator information corresponding to the browser is a URL.

In some embodiments, when the terminal cannot jump from the first application to the application corresponding to the target search engine, that is, a URL Scheme is not configured for the target search engine, the input method program of the terminal jumps from the first application to the browser based on the uniform resource locator information URL corresponding to the browser, and transmits the search term to the browser, to switch from the first application interface to the second application interface provided by the browser for displaying.

Based on this, the browser may obtain the search term, so that the search result obtained after a searching process of the search term on the website corresponding to the target search engine is displayed on the second application interface.

In some embodiments, the candidate search engine in the search engine list is associated with the first application. A background of the terminal may determine the search engine list according to related information of the first application.

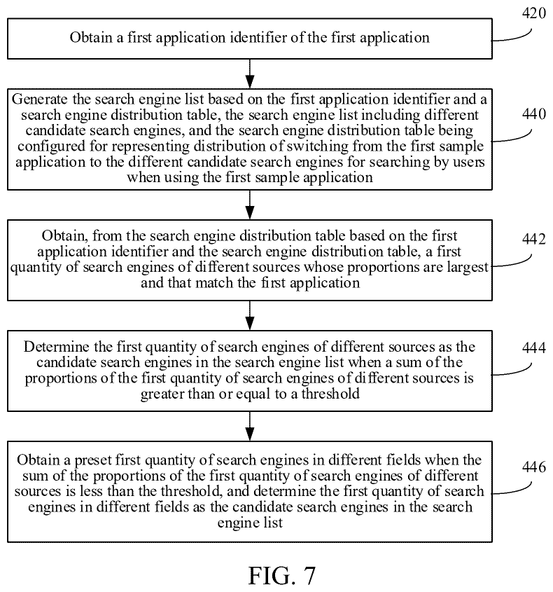

FIG. 7 is a schematic diagram of a content search method according to an exemplary embodiment of the present disclosure. Based on the foregoing embodiments, the method may further include the following operations.

Operation 420: Obtain a first application identifier of the first application.

The first application identifier is an identifier configured for uniquely representing the first application, and the first application identifier may be at least one of a symbol, a digit, a letter, or computer code.

For example, the input method program of the terminal obtains the first application identifier of the first application. In some embodiments, the first application identifier is a package name (Package Name) of the first application.

In some embodiments, the input method program of the terminal invokes a start input view (onStartInput View) interface, and obtains the package name of the first application based on a package name (packageName) attribute in editor information (EditorInfo) parameters of the start input view (onStartInput View) interface.

Operation 440: Generate the search engine list based on the first application identifier and a search engine distribution table, the search engine list including different candidate search engines, and the search engine distribution table being configured for representing distribution of switching from the first sample application to the different candidate search engines for searching by the users when using the first sample application.

The search engine distribution table is a list configured for representing the distribution of switching from the first application to the different candidate search engines for searching by the users when using the first application.

In some embodiments, the search engine distribution table includes ratios of quantities of users switching from the first application to the search engines of different sources when using the first application. Correspondingly, based on the first application identifier and the search engine distribution table, the search engine list may be generated in the following manner:
obtaining, from the search engine distribution table based on the first application identifier and the search engine distribution table, a first quantity of search engines of different sources that have largest user quantity ratios; determining the first quantity of search engines of different sources as the candidate search engines in the search engine list when a sum of the user quantity ratios of the first quantity of search engines is greater than or equal to a ratio threshold; and obtaining a preset first quantity of search engines in different fields when the sum of the user quantity ratios of the first quantity of search engines is less than the threshold, and determining the first quantity of search engines in different fields as the candidate search engines in the search engine list.

The user quantity ratio is explained herein. An example of a ratio of a quantity of users switching from the first application to a search engine A when using the first application is used. The user quantity ratio is a ratio of the quantity of users switching from the first application to the search engine A for searching when using the first application to a total user quantity. The total user quantity is a sum of a quantity of users using the first application (that is, program switching is not performed) and a quantity of users performing searching on the search engine A.

In some embodiments, the search engine distribution table includes three columns. A first column is configured for representing the first application, a second column is configured for representing a candidate search engine, and a third column is configured for representing a proportion (which may be the user quantity ratio mentioned above) corresponding to the candidate search engine. In some embodiments, in the search engine distribution table, the candidate search engines corresponding to the first application are sorted in descending order of the proportions.

For example, the input method program of the terminal generates the search engine list based on the first application identifier and the search engine distribution table.

In this embodiment, the corresponding search engine list is generated based on the first application identifier corresponding to the first application, so that the search engine list is associated with the first application, thereby effectively improving efficiency of determining the search engine list.

In some embodiments, if the candidate search engines in the search engine list are search engines of different sources, the candidate search engines in the search engine distribution table include the search engines of different sources. Still referring to FIG. 7, in one embodiment, operation 440 includes operation 442, operation 444, and operation 446.

Operation 442: Obtain, from the search engine distribution table based on the first application identifier and the search engine distribution table, a first quantity of search engines of different sources whose proportions are largest and that match the first application.

The first quantity is a preset quantity. For example, the first quantity is set to 5.

The first quantity of search engines of different sources that have the largest proportions are a first quantity of top search engines of different sources whose proportions rank the top. The proportion ranges from 0 to 1. For example, when the first quantity is set to 5, top 5 search engines of different sources whose proportions are largest are used.

For example, the input method program of the terminal obtains, from the search engine distribution table based on the first application identifier and the search engine distribution table, the first quantity of search engines of different sources whose proportions are largest and that match the first application.

Operation 444: Determine the first quantity of search engines of different sources as the candidate search engines in the search engine list when a sum of the proportions of the first quantity of search engines of different sources is greater than or equal to a threshold.

The threshold is a preset proportion, and the threshold may be set based on an actual technical requirement. For example, the threshold is set to 80%.

In some embodiments, the proportions of the first quantity of search engines of different sources are added, to obtain the sum of the proportions.

For example, when the sum of the proportions of the first quantity of search engines of different sources is greater than or equal to the threshold, it represents that the user expects to perform searching on the first quantity of search engines of different sources, and the first quantity of search engines of different sources are determined as the candidate search engines in the search engine list.

In some embodiments, in the search engine list, the first quantity of search engines of different sources are sequentially displayed in descending order of the proportions according to the proportions corresponding to the first quantity of search engines of different sources, that is, the candidate search engines are displayed.

Operation 446: Obtain a preset first quantity of search engines in different fields when the sum of the proportions of the first quantity of search engines of different sources is less than the threshold, and determine the first quantity of search engines in different fields as the candidate search engines in the search engine list.

For example, when the sum of the proportions of the first quantity of search engines of different sources is less than the threshold, it represents that the user does not expect to perform searching on the first quantity of search engines of different sources, or it represents that no search engine expected by the user exists in the search engine distribution table. In this case, the preset first quantity of search engines in different fields are obtained, and the first quantity of search engines in different fields are determined as the candidate search engines in the search engine list.

In some embodiments, in the search engine list, the first quantity of search engines in different fields are sequentially displayed in a preset order of the first quantity of search engines in different fields, that is, the candidate search engines are displayed.

For example, the search engines in different fields set in this embodiment include at least one of search engines in web page, e-commerce, video, music, and takeout fields.

A quantity of search engines in each field is limited. By using the video field as an example, search engines in the video field may be a plurality of preset partner video search engines that have a cooperation relationship with a current party, rather than all search engines in the video field in the current industry, thereby reducing costs.

In some embodiments, the search engine distribution table includes a destination search engine distribution table, where the destination search engine distribution table is obtained based on sample data, and the sample data is usage data of seed users on an application.

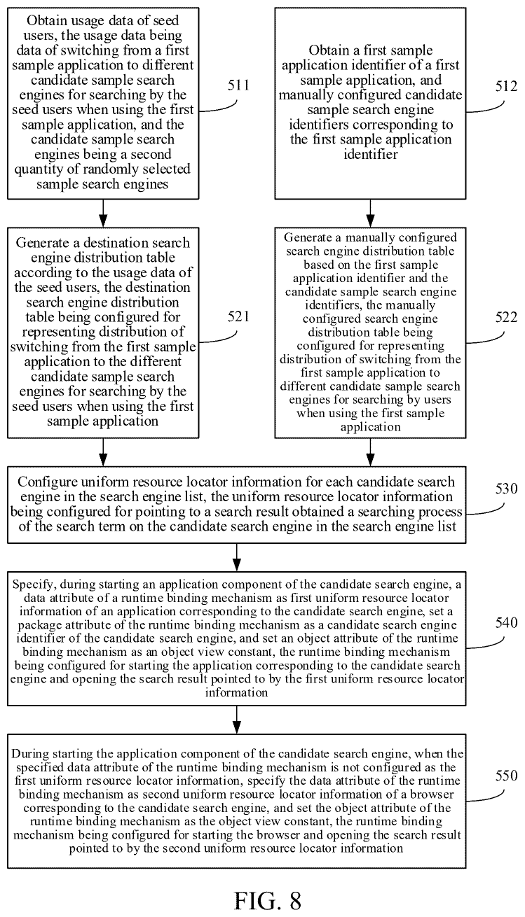

FIG. 8 is a flowchart of a content search method according to an exemplary embodiment of the present disclosure. Based on the embodiments of operation 442, operation 444, and operation 446, in one embodiment, the method further includes operation 511 and operation 521.

Operation 511: Obtain the usage data of the seed users, the usage data being data of switching from a first sample application to different candidate sample search engines for searching by the seed users when using the first sample application, and the candidate sample search engines being a second quantity of randomly selected sample search engines.

The seed users are a plurality of sample users.

The first sample application is a first application used by the seed users.

The candidate sample search engines are a plurality of candidate search engines provided for the seed users, and the candidate sample search engines are the second quantity of randomly selected sample search engines.

The random selection refers to performing random selection from all current sample search engines.

The second quantity is a preset quantity of sample search engines. The second quantity may be the same as or different from the first quantity. This is not limited in the present disclosure.

The usage data is the data of switching from the first sample application to the different candidate sample search engines for searching by the seed users when using the first sample application.

For example, the input method program of the terminal obtains the usage data of the seed users.

Operation 521: Generate the destination search engine distribution table according to the usage data of the seed users, the destination search engine distribution table being configured for representing distribution of switching from the first sample application to the different candidate sample search engines for searching by the seed users when using the first sample application.

The destination search engine distribution table is a list configured for representing the distribution of switching from the first sample application to the different candidate sample search engines for searching by the seed users when using the first sample application.

In some embodiments, the destination search engine distribution table includes three columns. A first column is configured for representing the first sample application, a second column is configured for representing a candidate sample search engine, and a third column is configured for representing a proportion corresponding to the candidate sample search engine. In some embodiments, in the destination search engine distribution table, the candidate sample search engines corresponding to the first sample application are sorted in descending order of the proportions.

For example, the input method program of the terminal generates the destination search engine distribution table according to the usage data of the seed users.

In an example, Table 1 provides a destination search engine distribution table according to an exemplary embodiment.

TABLE 1
Destination search engine distribution table

| Current application | Destination search engine | Ratio |
|---|---|---|
| (first sample application) | (candidate sample search engine) | (proportion) |
| Application A | Search engine a | 50% |
| | Search engine b | 20% |
| | Search engine c | 15% |
| | Search engine d | 10% |
| | Search engine e | 10% |
| | Search engine f | 10% |
| | Search engine g | 5% |
| Application B | Search engine a | 5% |
| | Search engine b | 4% |
| | Search engine c | 3% |
| | Search engine d | 2% |
| | Search engine e | 2% |
| | Search engine f | 1% |
| | Search engine g | 1% |

In the destination search engine distribution table, the first column is configured for representing the first sample application, the second column is configured for representing a candidate sample search engine, the third column is configured for representing a proportion corresponding to the candidate sample search engine, and the candidate sample search engines are sorted in descending order of the proportions.

For example, when the seed users use a content search function on the application A, 50% of the seed users select to switch to the search engine a.

It is assumed that the first application is the application A, the first quantity is 5, and the threshold is set to 80%. From the destination search engine distribution table, top five search engines whose proportions are largest and that correspond to the application A: the search engine a, the search engine b, the search engine c, the search engine d, and the search engine e, are obtained; and a sum of the corresponding proportions is 105%, and is greater than the threshold 80%. In this case, the search engine a, the search engine b, the search engine c, the search engine d, and the search engine e are determined as the candidate search engines in the search engine list when the application A is used. For displaying, reference may be made to Part (a) in FIG. 5.

It is assumed that the first application is an application B, the first quantity is 5, and the threshold is set to 80%. From the destination search engine distribution table, top five search engines whose proportions are largest and that correspond to the application B: the search engine a, the search engine b, the search engine c, the search engine d, and the search engine e, are obtained; and a sum of the corresponding proportions is 16%, and is less than the threshold 80%. In this case, five preset search engines in different fields: search engines in the web page, e-commerce, video, music, and takeout fields, are obtained as the candidate search engines in the search engine list when the application B is used. For displaying, reference may be made to Part (b) in FIG. 5.

In some embodiments, the search engine distribution table includes a manually configured search engine distribution table, and the manually configured search engine distribution table is a manually preconfigured list.

Still referring to FIG. 8, based on the embodiments of operation 442, operation 444, and operation 446, in one embodiment, the method further includes operation 512 and operation 522.

Operation 512: Obtain a first sample application identifier of a first sample application, and manually configured candidate sample search engine identifiers corresponding to the first sample application identifier.

The first sample application identifier is an identifier configured for uniquely representing the first sample application, and the first sample application identifier may be at least one of a symbol, a digit, a letter, or computer code.

A candidate sample search engine identifier is an identifier configured for uniquely representing a candidate sample application, and the identifier of the candidate sample application may be at least one of a symbol, a digit, a letter, or computer code.

In some embodiments, the first sample application identifier is a package name of the first sample application.

In some embodiments, different search engine lists are manually configured for different first sample application identifiers, and the first sample application identifier corresponds to the candidate sample search engine identifiers, to complete configuration.

For example, the input method program of the terminal obtains the first sample application identifier of the first sample application, and the manually configured candidate sample search engine identifiers corresponding to the first sample application identifier.

Operation 522: Generate the manually configured search engine distribution table based on the first sample application identifier and the candidate sample search engine identifiers, the manually configured search engine distribution table being configured for representing distribution of switching from the first sample application to different candidate sample search engines for searching by the users when using the first sample application.

For example, the input method program of the terminal generates the manually configured search engine distribution table based on the first sample application identifier and the candidate sample search engine identifiers, the manually configured search engine distribution table being configured for representing the distribution of switching from the first sample application to the different candidate sample search engines for searching by the users when using the first sample application.

For example, a search engine list manually configured for a package name of an e-commerce application A includes: an e-commerce search engine B, an e-commerce search engine C, and an e-commerce search engine D.

In some embodiments, a priority of the manually configured search engine distribution table is higher than a priority of the destination search engine distribution table. To be specific, when the terminal is configured with the manually configured search engine distribution table and the destination search engine distribution table, the candidate search engines are determined based on content of the manually configured search engine distribution table.

In the foregoing embodiment, the destination search engine distribution table is preconfigured based on usage information of a plurality of seed users, so that a situation in which the user actually uses a search engine can be fully considered. The manually configured search engine distribution table is preconfigured, so that configuration of a search engine can be more accurate. In this way, when the candidate search engines are determined according to the destination search engine distribution table or the manually configured search engine distribution table, efficiency and precision of determining the candidate search engines can be improved.

In some embodiments, after the user selects a target search engine in the search engine list, the terminal needs to jump to a corresponding application. Because each candidate search engine may be used as the selected target search engine, some parameters need to be configured for each candidate search engine after each candidate search engine in the search engine list is determined. In this way, the terminal can jump to the corresponding application.

Still referring to FIG. 8, based on operation 511 and operation 521, and operation 512 and operation 522, the method further includes operation 530.

Operation 530: Configure uniform resource locator information for each candidate search engine in the search engine list, the uniform resource locator information being configured for pointing to a search result obtained after a searching process of the search term on the candidate search engine in the search engine list.

The uniform resource locator information is configured for pointing to the search result obtained after a searching process of the search term on the candidate search engine in the search engine list.

For example, the input method program of the terminal configures the uniform resource locator information for each candidate search engine in the search engine list.

In some embodiments, the uniform resource locator information includes one of a URL Scheme and a URL, where the URL is essential information, and the URL Scheme is non-essential information.

For example, the URL or the URL Scheme is spliced in a manner of “fixed prefix text”+search term (Query)+“fixed suffix text”, to point to a search result page obtained after a searching process of the search term on the candidate search engine. A splicing rule of the URL or the URL Scheme is from a rule disclosed by each candidate search engine or a splicing rule provided by a partner search engine.

In some embodiments, the uniform resource locator information includes first uniform resource locator information. The first uniform resource locator information is the URL Scheme. When the URL Scheme is configured, the terminal jumps to an application corresponding to the candidate search engine.

Still referring to FIG. 8, in one embodiment, operation 530 is implemented as operation 540.

Operation 540: Specify, during starting an application component of the candidate search engine, a data attribute of a runtime binding mechanism as the first uniform resource locator information of the application corresponding to the candidate search engine, set a package attribute of the runtime binding mechanism as a candidate search engine identifier of the candidate search engine, and set an object attribute of the runtime binding mechanism as an object view constant, the runtime binding mechanism being configured for starting the application corresponding to the candidate search engine and opening the search result pointed to by the first uniform resource locator information.

The runtime binding mechanism (Intent) is also referred to as dynamic binding, and is a mechanism for invoking an object method. The runtime binding mechanism is configured for starting the application corresponding to the candidate search engine and opening the search result pointed to by the first uniform resource locator information.

The candidate search engine identifier is a package name of the application corresponding to the candidate search engine.

For example, during starting the application component (Activity) of the candidate search engine, the data (mData) attribute of the runtime binding mechanism (Intent) is specified as the first uniform resource locator information (URL Scheme) of the application corresponding to the candidate search engine, the package (mPackage) attribute of the runtime binding mechanism (Intent) is set as the candidate search engine identifier (package name) of the candidate search engine, and the object (mAction) attribute of the runtime binding mechanism is set as the object view constant (Intent.ACTION_VIEW constant). A search page pointed to by the specified URL Scheme of the application corresponding to the candidate search engine may be pulled up based on the runtime binding mechanism (Intent).

In some embodiments, the uniform resource locator information includes second uniform resource locator information, and the second uniform resource locator information is the URL. When the URL is configured, the terminal jumps to a browser.

Still referring to FIG. 8, in one embodiment, based on operation 540, the method further includes operation 550.

Operation 550: During starting the application component of the candidate search engine, when the specified data attribute of the runtime binding mechanism is not configured as the first uniform resource locator information, specify the data attribute of the runtime binding mechanism as the second uniform resource locator information of the browser corresponding to the candidate search engine, and set the object attribute of the runtime binding mechanism as the object view constant, the runtime binding mechanism being configured for starting the browser and opening the search result pointed to by the second uniform resource locator information.

The runtime binding mechanism (Intent) is also referred to as dynamic binding, and is the mechanism for invoking an object method. The runtime binding mechanism is further configured for starting the browser and opening the search result pointed to by the second uniform resource locator information.

For example, during starting the application component (Activity) of the candidate search engine, if the data (mData) attribute of the specified runtime binding mechanism (Intent) is not configured as the first uniform resource locator information (URL Scheme), the data (mData) attribute of the specified runtime binding mechanism (Intent) is specified as the second uniform resource locator information (URL) of the browser corresponding to the candidate search engine, and the object (mAction) attribute of the runtime binding mechanism is set as the object view constant (Intent.ACTION_VIEW constant). A search page pointed to by the specified URL of the browser corresponding to the candidate search engine may be pulled up based on the runtime binding mechanism (Intent).

For example, the browser corresponding to the candidate search engine is a default browser that is installed on the terminal and configured to start a web page. For example, when a browser A and a browser B are installed on the terminal, and the user sets the browser B as the default browser of the terminal, the browser corresponding to the candidate search engine is the browser B.

In the foregoing embodiment, related information of the runtime binding mechanism is configured for each candidate search engine, so that no matter which candidate search engine the user selects as the target search engine, the terminal can directly switch from the first application to the second application.

In some embodiments, the foregoing embodiments are performed based on a case in which the input method program of the terminal obtains the search term. However, in the plurality of manners in which the input method program obtains the search term, whether the first application provides a search box needs to be first determined.

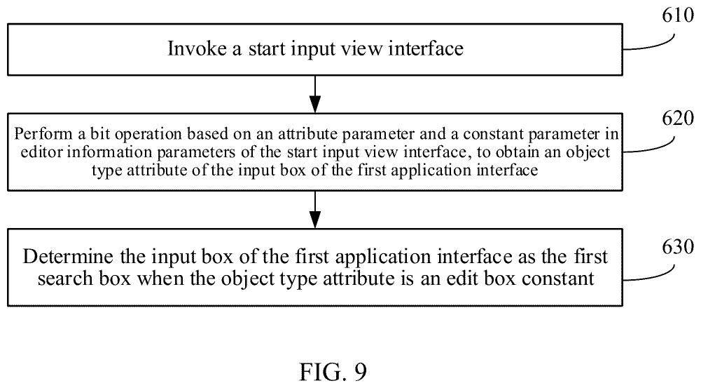

FIG. 9 is a flowchart of a content search method according to an embodiment of the present disclosure. Based on the foregoing embodiments, the method may further include the following operations.

Operation 610: Invoke a start input view interface.

In some embodiments, the input method program of the terminal invokes the start input view (onStartInput View) interface.

Operation 620: Perform a bit operation based on an attribute parameter and a constant parameter in editor information parameters of the start input view interface, to obtain an object type attribute of the input box of the first application interface.

For example, the input method program of the terminal performs the bit operation based on the attribute (imeOptions) parameter and the constant (EditorInfo.IME_MASK_ACTION and EditorInfo.IME_FLAG_NO_ENTER_ACTION) parameter in the editor information (EditorInfo) parameters of the start input view (onStartInput View) interface, to obtain the object type (actionType) attribute of the content input area of the first application interface.

Operation 630: Determine the input box of the first application interface as the first search box when the object type attribute is an edit box constant.

For example, the content input area of the first application interface is determined as the first search box when the object type (actionType) attribute is the edit box constant (EditorInfo.IME_ACTION_SEARCH).

In some embodiments, the input method program of the terminal may determine whether the content input area of the first application interface is the first search box provided by the first application, so that the input method program can determine whether the input method program directly obtains the search term or provide the second search box to obtain the search term, thereby improving efficiency of obtaining the search term.

In the related art, an application on a terminal only provides content retrieval based on the application, which intercepts content of another application. In this way, when searching for same content, a user needs to open N applications to obtain a search result, causing much inconvenience. If the user has a requirement of perform searching by switching an App, a solution of directly opening a target App from a current App and opening a search result is not provided in the related art. The user needs to manually perform a plurality of operations.
1. Close the current App or switch to a background, to return to a mobile phone desktop.
2. Find the target App from the mobile phone desktop, and click to open the target App. If the mobile phone desktop has applications on a plurality of screens, the user further needs to search for the target App on different screens.
3. Find a search box on the target App and click on the search box, to invoke a keyboard.
4. Input a search term (Query).
5. Click on a search button and open a search result.

For example, for a TV series, if the user is using a short video application, the user can only obtain a short video search result for the TV series on the short video application; or if the user is using a long video application, the user can only obtain a long video search result for the TV series on the long video application. When the user is interested in the TV series on the short video application and expects to watch a long video, the user needs to first close the short video application or switch to the background, to return to the mobile phone desktop; find the long video application and click to open the long video application; input a name of the TV series in a search box of the long video application; click on a search button, and open a long video search result for the TV series.

In the content search method provided in the embodiments of the present disclosure, only three operations need to be performed.
1. Click on a function button on a keyboard on the current App.
2. Input the Query into a displayed search box. In some scenarios, the Query even does not need to be manually inputted.
3. Select and click on a search engine from a displayed search engine list, where after the clicking, an App corresponding to the search engine is opened, and a search result is opened.

Based on this, in the embodiments of the present disclosure, the user does not need to manually perform the two operations: “Close the current App or switch to a background”, and “Find the target App from the mobile phone desktop, and click to open the target App”, thereby greatly improving efficiency of performing searching by switching the App.

For example, when the user is interested in the TV series on the short video application and expects to watch the long video, an input method program is started on the short video application, the input method program automatically obtains the name of the TV series, and the input method program displays a search engine list, where the search engine list may include a plurality of video search engines. The user may select and click on a long video search engine from the search engine list. In this case, a long video application of the long video search engine or a browser may be directly invoked, to display the long video search result for the TV series.

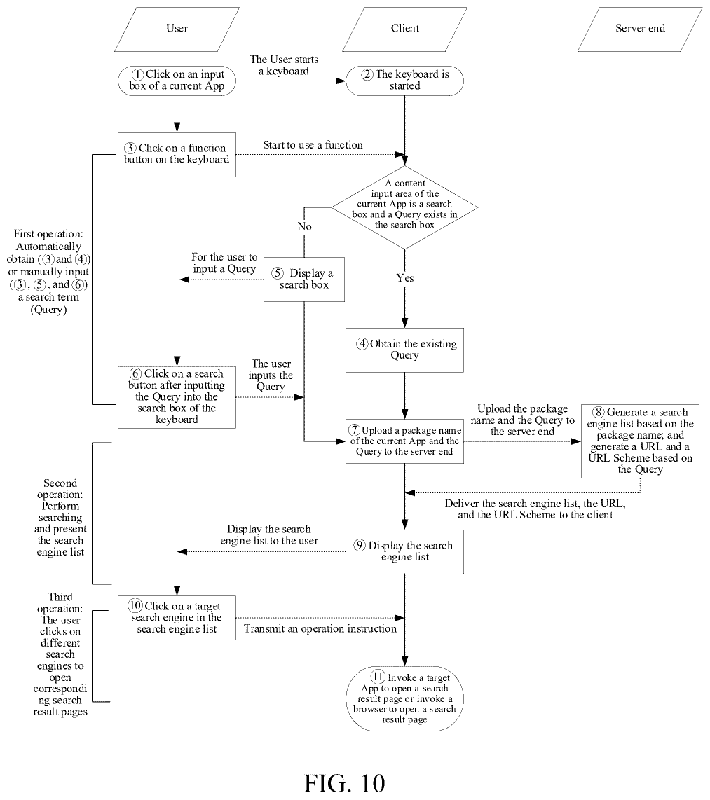

In an example, the content search method provided in the embodiments of the present disclosure is described with reference to a schematic diagram. FIG. 10 is a schematic diagram of a content search method according to an exemplary embodiment of the present disclosure. This embodiment mainly relates to a user, a client (a client corresponding to an input method program of a terminal), and a server end (a background of the terminal or a server). A first application is a current App, a second application is a target App, and an input method control of the input method program is a keyboard.

Referring to FIG. 10, a use operation process in this embodiment mainly includes three stages.

### I. Description of the Use Operation Process

### 1. First Stage: Automatically Obtain or Manually Input a Search Term (Query)

\textcircled{1} The user clicks on a content input area of the current App, to start the keyboard.
\textcircled{2} The keyboard is started.
\textcircled{3} The user clicks on a function button on the keyboard, to start using a function. In this case, the client determines whether the content input area of the current App is a search box and a Query exists in the search box; and performs \textcircled{4} if the content input area of the current App is the search box and the Query exists in the search box; or performs \textcircled{5} if the content input area of the current App is not the search box.
\textcircled{4} Automatically obtain the text as the search term Query. In this case, the client automatically obtains the Query.
\textcircled{5} Display a search box on the keyboard, for the user to input a Query.
\textcircled{6} The user clicks on a search button after inputting the Query into the search box of the keyboard. In this case, the client obtains the manually inputted Query, and enters a next stage.

### 2. Second Stage: Generate and Display a Search Engine List

\textcircled{7} The client uploads a package name of the current App and the Query to the server end.
\textcircled{8} The server end generates the search engine list based on the package name, and configures a URL or a URL Scheme for each candidate search engine in the search engine list. The URL or the URL Scheme points to a search result page obtained after a searching process of the Query on the search engine. The URL is essentially configured, and the URL Scheme is not non-essentially configured.
\textcircled{9} The server end delivers the search engine list and the corresponding URL or URL Scheme to the client, and the client displays the search engine list to the user, and enters a next stage.

### 3. Third Stage: Open a Search Result Page

\textcircled{10} The user clicks on a target search engine in the search engine list.
\textcircled{11} If a URL Scheme is configured for the target search engine, after the clicking, the keyboard opens an App corresponding to the target search engine, and opens a search result page obtained after a searching process of the Query on the App. If the URL Scheme is not configured or the keyboard fails to open the App, the keyboard opens a browser and opens a search result page obtained after a searching process of the Query on a website corresponding to the target search engine.

### II. Description of Key Technologies

### 1. Method for Determining Whether the Content Input Area is a Search Box

As described above, the client needs to determine whether the content input area of the current App is the search box, and automatically obtains the text in the search box as the Query if the content input area of the current App is the search box.

Determining method: The keyboard invokes an onStartInput View interface provided by a mobile phone system; performs a bit operation based on an imeOptions attribute, EditorInfo.IME_MASK_ACTION, and EditorInfo.IME_FLAG_NO_ENTER_ACTION in EditorInfo parameters of the interface, to obtain an actionType attribute of the content input area; and determines the current content input area as the search box if the actionType is equal to an edit box constant EditorInfo.IME_ACTION_SEARCH.

### 2. Method for Obtaining the Package Name of the Current App

As described above, the client needs to obtain the package name of the current App. The obtaining method includes the following operations.

The keyboard invokes the onStartInput View interface provided by the mobile phone system, and obtains the package name of the current App based on a packageName attribute in the EditorInfo parameters of the interface.

### 3. Method for Generating the Search Engine List

If behaviors (or operations) of opening other search engines on the current App are highly concentrated in five search engines, the list generated by using the function on the App is formed by the five search engines. Otherwise, the list is formed by five type search engines. The generating method includes the following operations.

### (1) Acquire Training Data Based on Seed Users

In an early stage, the function is provided for only a small quantity of users (seed users for short). When the seed users use the function, the five search engines included in the search engine list are randomly selected from dozens of search engines.

### (2) Create a “Destination Search Engine Distribution Table”

Usage data of the seed users is acquired, and the “destination search engine distribution table” is created, as shown in Table 1.

### (3) Generate the Search Engine List by Means of Retrieval and Calculation

After receiving the packet name of the current App uploaded by the client, the server end retrieves the packet name in the “destination search engine distribution table” and performs calculation on five search engines whose ratios are largest (Top5 for short).

If a sum of the ratios of Top5 is greater than or equal to 80% (a tentative threshold), the search engine list is formed by the Top5 search engines. Otherwise, the search engine list is formed by the five type search engines.

For example, referring to Table 1, if the function is used in an App A, the search engine list includes: search engines a, b, c, d, and e; or if the function is used in an APP B, the search engine list includes: a web page search engine, an e-commerce search engine, a video search engine, a music search engine, and a takeout search engine.

### (4) Manually Configured Search Engine List

Different search engine lists may be manually configured for package names of different APPs. A priority of the manually configured list is higher than that of the list generated by using the foregoing algorithm (3).

For example, a search engine list manually configured for a package name of an e-commerce App A may include: an e-commerce search engine B, an e-commerce search engine C, and an e-commerce search engine D.

### 4. Method for Generating a URL and a URL Scheme

### (1) The Server End Generates a URL or a URL Scheme for Each Candidate Search Engine in the Search Engine List, Where the URL is Essential, and the URL Scheme is Non-Essential

### (2) The URL or the URL Scheme is Spliced in a Manner of “Fixed Prefix Text”30 Query+“Fixed Suffix Text”, to Point to a Search Result Page Obtained After a Searching Process of the Query on the Search Engine

### (3) A Splicing Rule of the URL or the URL Scheme is From a Rule Disclosed by Each Search Engine or a Splicing Rule Provided by a Partner Search Engine

### 5. Method in Which the Keyboard Opens the Target App and Opens the Search Result Page

The user clicks on the target search engine in the search engine list. If the URL Scheme is configured for the target search engine, the target App corresponding to the target search engine is opened, and the search result page is opened.

For example, when an Activity is started, an mData attribute of Intent is specified as the URL Scheme of the target App, an mPackage attribute of the Intent is set as a target package name, and an mAction attribute of the Intent is set as an Intent.ACTION_VIEW constant. The search result page pointed to by the specified URL Scheme of the target App may be pulled up based on the Intent.

### 6. Method in Which the Keyboard Opens the Browser and Opens the Search Result Page

If the URL Scheme is not configured for the target search engine clicked on by the user, the browser is opened, and the search result page is opened on the browser.

For example, when the Activity is started, the mData attribute of the Intent is specified as a target URL, and the mAction attribute is set as the Intent.ACTION_VIEW constant. Based on the Intent, a default browser of the system may be started, to open the search result page pointed to by the URL.

In conclusion, according to the method provided in this embodiment of the present disclosure, when a user performs searching by switching an application, the user does not need to close a currently used first application and then start a second application that the user intends to use, and does not need to repeatedly input a search term into the second application. In this way, operations are reduced, a second application interface can be directly switched to, and a search result can be displayed, so that efficiency of performing searching by switching the application is effectively improved, and operations are more convenient. In addition, the user can find expected content, service, commodity, and the like more quickly, and user experience can further be effectively improved.

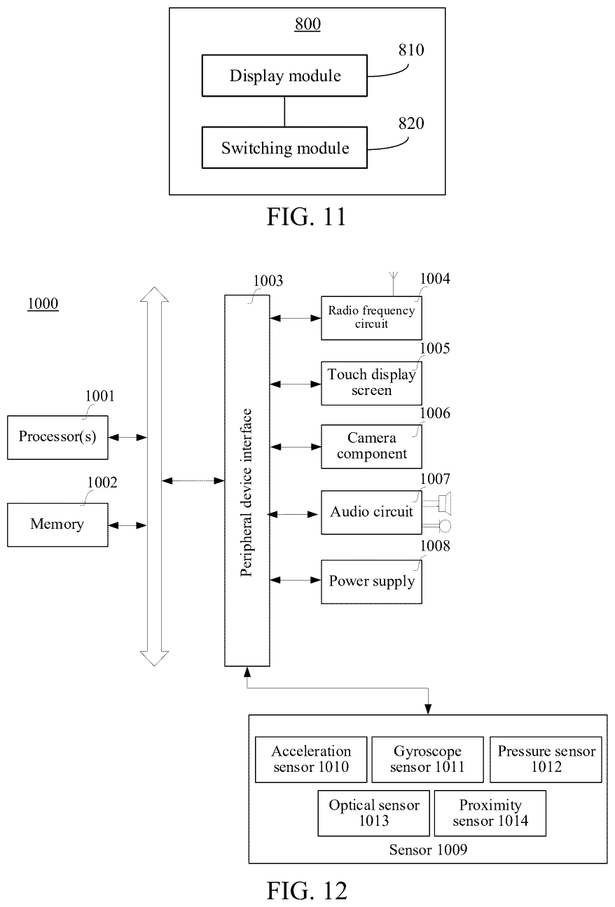

FIG. 11 is a structural block diagram of a content search apparatus according to an exemplary embodiment of the present disclosure. A content search apparatus 800 includes:
a display module 810, configured to obtain a search term from a content input area of a first application interface, and display a candidate search engine; and
a switching module 820, configured to switch from the first application interface to a second application interface in response to a selection operation on a target search engine in the candidate search engine,
a search result obtained after a searching process of the search term on the target search engine being displayed on the second application interface.

In some embodiments, the display module 810 is further configured to display an input method program based on the content input area of the first application interface; and obtain, through the input method program, the search term from the content input area of the first application interface.

In some embodiments, the input method program includes an intelligent search control; and the display module 810 is further configured to obtain, in response to a trigger operation on the intelligent search control, the search term from the content input area of the first application interface if the content input area includes the search term.

In some embodiments, the input method program includes a first content input area and an intelligent search control; and the display module 810 is further configured to display, in response to a trigger operation on the intelligent search control, a second content input area if the first content input area does not include the search term; and
obtain an inputted search term from the second content input area in response to a search term input operation in the second content input area.

In some embodiments, the input method program includes an intelligent search control; and the display module 810 is further configured to display the content input area on the first application interface in response to a trigger operation on the intelligent search control; and
obtain an inputted search term from the content input area in response to a search term input operation in a second content input area.

In some embodiments, the display module 810 is configured to:
display the search engine list in a display area of an input method control of the input method program in response to that the input method program obtains the search term from the content input area of the first application interface,
the candidate search engines in the search engine list including search engines of different sources, and the search engines of different sources including search engines corresponding to different websites or different applications.

In some embodiments, the display module 810 is configured to:
display the search engine list in a display area of an input method control of the input method program in response to that the input method program obtains the search term from the content input area of the first application interface,
the candidate search engines in the search engine list including search engines in different fields.

In some embodiments, the display module 810 is configured to:
when a first search box is displayed on the first application interface and a search term exists in the first search box, obtain, through the input method program, the search term from the first search box, and display the search engine list in the display area of the input method control of the input method program.

In some embodiments, the display module 810 is further configured to:
display a second search box in the display area of the input method control of the input method program when the first search box is displayed on the first application interface and no search term exists in the first search box; and
obtain, through the input method program, a search term from the second search box in response to a search term input operation on the second search box, and display the search engine list in the display area of the input method control of the input method program.

In some embodiments, the display module 810 is further configured to:
display a second search box in the display area of the input method control of the input method program when the first search box is not displayed on the first application interface; and
obtain, through the input method program, a search term from the second search box in response to a search term input operation on the second search box, and display the search engine list in the display area of the input method control of the input method program.

In some embodiments, a second application includes an application corresponding to the target search engine; and the switching module 820 is configured to:
in response to the selection operation on the target search engine in the candidate search engine, jump from a first application to the application corresponding to the target search engine based on uniform resource locator information corresponding to the application of the target search engine; and transmit the search term to the application corresponding to the target search engine, to switch from the first application interface to the second application interface provided by the second application for displaying.

In some embodiments, the second application includes a browser; and the switching module 820 is configured to:
when the jump is incapable of being performed from the first application to the application corresponding to the target search engine, jump from the first application to the browser based on uniform resource locator information corresponding to the browser; and transmit the search term to the browser, to switch from the first application interface to the second application interface provided by the browser for displaying.

In some embodiments, the apparatus further includes an obtaining module.

In some embodiments, the obtaining module is configured to:
obtain a first application identifier of the first application.

In some embodiments, the apparatus further includes a generation module.

In some embodiments, the generation module is configured to:
generate the search engine list based on the first application identifier and a search engine distribution table,
the search engine list including different candidate search engines, and the search engine distribution table being configured for representing distribution of switching from the first sample application to the different candidate search engines for searching by users when using the first sample application.

In some embodiments, the candidate search engines in the search engine distribution table include search engines of different sources, and the search engine distribution table includes ratios of quantities of users switching from the first application to the search engines of different sources when using the first application; and
the generation module is further configured to obtain, from the search engine distribution table based on the first application identifier and the search engine distribution table, a first quantity of search engines of different sources that have largest user quantity ratios;
determine the first quantity of search engines of different sources as the candidate search engines in the search engine list when a sum of the user quantity ratios of the first quantity of search engines is greater than or equal to a ratio threshold; and
obtain a preset first quantity of search engines in different fields when the sum of the user quantity ratios of the first quantity of search engines is less than the threshold, and determine the first quantity of search engines in different fields as the candidate search engines in the search engine list.

In some embodiments, the generation module is configured to:
obtain, from the search engine distribution table based on the first application identifier and the search engine distribution table, a first quantity of search engines of different sources whose proportions are largest and that match the first application;
determine the first quantity of search engines of different sources as the candidate search engines in the search engine list when a sum of the proportions of the first quantity of search engines of different sources is greater than or equal to a threshold; and
obtain a preset first quantity of search engines in different fields when the sum of the proportions of the first quantity of search engines of different sources is less than the threshold, and determine the first quantity of search engines in different fields as the candidate search engines in the search engine list.

In some embodiments, the search engine distribution table includes a destination search engine distribution table.

In some embodiments, the obtaining module is further configured to:
obtain usage data of seed users, the usage data being data of switching from a first sample application to different candidate sample search engines for searching by the seed users when using the first sample application, and the candidate sample search engines being a second quantity of randomly selected sample search engines.

In some embodiments, the generation module is further configured to:
generate the destination search engine distribution table according to the usage data of the seed users,
the destination search engine distribution table being configured for representing distribution of switching from the first sample application to the different candidate sample search engines for searching by the seed users when using the first sample application.

In some embodiments, the search engine distribution table includes a manually configured search engine distribution table.

In some embodiments, the obtaining module is configured to:
obtain a first sample application identifier of a first sample application, and manually configured candidate sample search engine identifiers corresponding to the first sample application identifier.

In some embodiments, the generation module is configured to:
generate the manually configured search engine distribution table based on the first sample application identifier and the candidate sample search engine identifiers,
the manually configured search engine distribution table being configured for representing distribution of switching from the first sample application to different candidate sample search engines for searching by users when using the first sample application.

In some embodiments, the apparatus further includes a configuration module.

In some embodiments, the configuration module is configured to:
configure uniform resource locator information for each candidate search engine in the search engine list,
the uniform resource locator information being configured for pointing to a search result obtained after a searching process of the search term on the candidate search engine in the search engine list.

In some embodiments, the uniform resource locator information includes first uniform resource locator information.

In some embodiments, the configuration module is configured to:
specify, during starting an application component of the candidate search engine, a data attribute of a runtime binding mechanism as the first uniform resource locator information of an application corresponding to the candidate search engine, set a package attribute of the runtime binding mechanism as a candidate search engine identifier of the candidate search engine, and set an object attribute of the runtime binding mechanism as an object view constant,
the runtime binding mechanism being configured for starting the application corresponding to the candidate search engine and opening the search result pointed to by the first uniform resource locator information.

In some embodiments, the uniform resource locator information includes second uniform resource locator information.

In some embodiments, the configuration module is further configured to:
during starting the application component of the candidate search engine, when the specified data attribute of the runtime binding mechanism is not configured as the first uniform resource locator information, specify the data attribute of the runtime binding mechanism as the second uniform resource locator information of a browser corresponding to the candidate search engine, and set the object attribute of the runtime binding mechanism as the object view constant,
the runtime binding mechanism being configured for starting the browser and opening the search result pointed to by the second uniform resource locator information.

In some embodiments, the apparatus further includes a determining module.

In some embodiments, the determining module is configured to:
invoke a start input view interface;
perform a bit operation based on an attribute parameter and a constant parameter in editor information parameters of the start input view interface, to obtain an object type attribute of the content input area of the first application interface; and
determine the content input area of the first application interface as the first search box when the object type attribute is an edit box constant.

For limitations in one or more embodiments of the content search apparatus provided above, reference may be made to the limitations on the foregoing content search method. Details are not repeated herein again. The modules in the foregoing apparatus may be implemented entirely or partially by software, hardware, or combinations thereof. The modules may be built in or independent of a processor of a computer device in a hardware form, or may be stored in a memory of the computer device in a software form, so that the processor invokes and performs an operation corresponding to each of the modules.

FIG. 12 is a structural block diagram of a computer device according to an exemplary embodiment of the present disclosure.

A computer device 1000 may be a portable mobile terminal, for example, a smartphone, a tablet computer, a moving picture experts group audio layer III (MP3) player, or a moving picture experts group audio layer IV (MP4) player. The term of the computer device 1000 may also be referred to as, for example, user equipment or a portable terminal.

Generally, the computer device 1000 includes a processor 1001 and a memory 1002.

The processor 1001 may include one or more processing cores, such as a 4-core processor or an 8-core processor. The processor 1001 may be implemented by using at least one hardware form of a digital signal processor (DSP), a field programmable gate array (FPGA), and a programmable logic array (PLA). The processor 1001 may alternatively include a main processor and a coprocessor. The main processor is configured to process data in an active state, also referred to as a central processing unit (CPU). The coprocessor is a low-power consumption processor configured to process data in a standby state. In some embodiments, the processor 1001 may be integrated with a graphics processing unit (GPU). The GPU is configured to render and draw content that needs to be displayed on a display. In some embodiments, the processor 1001 may further include an artificial intelligence (AI) processor. The AI processor is configured to process computing operations related to machine learning.

The memory 1002 may include one or more computer-readable storage media. The computer-readable storage medium may be tangible and non-transient. The memory 1002 may also include a high-speed random access memory, as well as non-volatile memory, such as one or more disk storage devices and flash storage devices. In some embodiments, a non-transitory computer-readable storage medium in the memory 1002 is configured to store at least one instruction, the at least one instruction being configured to be executed by the processor 1001 to implement the content search method provided in the embodiments of the present disclosure.

In some embodiments, the computer device 1000 further includes a peripheral device interface 1003 and at least one peripheral device. For example, the peripheral device includes at least one of a radio frequency circuit 1004, a touch display screen 1005, a camera component 1006, an audio circuit 1007, and a power supply 1008.

The peripheral device interface 1003 may be configured to connect at least one peripheral device related to input/output (I/O) to the processor 1001 and the memory 1002. In some embodiments, the processor 1001, the memory 1002, and the peripheral device interface 1003 are integrated on the same chip or the same circuit board. In some other embodiments, any or both of the processor 1001, the memory 1002, and the peripheral device interface 1003 may be implemented on an independent chip or circuit board, which is not limited in the embodiments.

The radio frequency circuit 1004 is configured to receive and transmit a radio frequency (RF) signal, which is also referred to as an electromagnetic signal. The radio frequency circuit 1004 communicates with a communication network and other communication devices through the electromagnetic signal. The radio frequency circuit 1004 converts an electric signal into an electromagnetic signal for transmission, or converts a received electromagnetic signal into an electric signal. In some embodiments, the radio frequency circuit 1004 includes: an antenna system, an RF transceiver, one or more amplifiers, a tuner, an oscillator, a digital signal processor, a codec chip set, a subscriber identity module card, and the like. The radio frequency circuit 1004 may communicate with other terminals through at least one wireless communication protocol. The wireless communication protocol includes, but not limited to a world wide web, a metropolitan area network, an intranet, generations of mobile communication networks (2G, 3G, 4G, and 5G), a wireless local area network, and/or a wireless fidelity (Wi-Fi) network. In some embodiments, the radio frequency circuit 1004 may further include a circuit related to near field communication (NFC), which is not limited in the present disclosure.

The touch display screen 1005 is configured to display a user interface (UI). The UI may include a graph, a text, an icon, a video, and any combination thereof. The touch display screen 1005 also has a capability of acquiring a touch signal on or above a surface of the touch display screen 1005. The touch signal may be inputted, as a control signal, into the processor 1001 for processing. The touch display screen 1005 is configured to provide a virtual button and/or a virtual keyboard, which is also referred to as a soft button and/or a soft keyboard. In some embodiments, there may be one touch display screen 1005, arranged on a front panel of the computer device 1000. In some other embodiments, there are at least two touch display screens 1005, arranged on different surfaces of the computer device 1000 respectively or in a folded design. In some embodiments, the touch display screen 1005 may be a flexible display screen, arranged on a curved surface or a folded surface of the computer device 1000. Even, the touch display screen 1005 may be further set in a non-rectangular irregular pattern, namely, a special-shaped screen. The touch display screen 1005 may be prepared in the form of a liquid crystal display (LCD), an organic light-emitting diode (OLED), or the like.

The camera component 1006 is configured to acquire an image or a video. In some embodiments, the camera component 1006 includes a front-facing camera and a rear-facing camera. Generally, the front-facing camera is configured to implement a video call or self-portrait. The rear-facing camera is configured to shooting a picture or a video. In some embodiments, there are at least two rear-facing cameras, each of which is any one of a main camera, a depth of field camera and a wide-angle camera, to implement a background blurring function by fusing the main camera and the depth of field camera, and panoramic shooting and virtual reality (VR) shooting functions by fusing the main camera and the wide-angle camera. In some embodiments, the camera component 1006 may further include a flash. The flash may be a single color temperature flash or a double color temperature flash. The double color temperature flash is a combination of a warm flash and a cold flash, and may be configured to perform light ray compensation at different color temperatures.

The audio circuit 1007 is configured to provide an audio interface between a user and the computer device 1000. The audio circuit 1007 may include a microphone and a speaker. The microphone is configured to acquire sound waves of users and surroundings, and convert the sound waves into electrical signals and input the signals to the processor 1001 for processing, or input the signals to the RF circuit 1004 to implement voice communication. For the purpose of stereo sound acquisition or noise reduction, there may be a plurality of microphones, respectively arranged at different parts of the computer device 1000. The microphone may be further an array microphone or an omnidirectional acquisition microphone. The speaker is configured to convert the electrical signal from the processor 1001 or the radio frequency circuit 1004 into sound waves. The speaker may be a suitable thin-film speaker or a piezoelectric ceramic speaker. When the speaker is the piezoelectric ceramic speaker, the speaker can not only convert an electrical signal into sound waves audible to a human being, but also convert an electrical signal into sound waves inaudible to the human being for ranging and other purposes. In some embodiments, the audio circuit 1007 may also include an earphone jack.

The power supply 1008 is configured to supply power to components in the computer device 1000. The power supply 1008 may be an alternating current, a direct current, a primary battery, or a rechargeable battery. When the power supply 1008 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the computer device 1000 may further include one or more sensors 1009. The one or more sensors 1009 include, but not limited to, an acceleration sensor 1010, a gyroscope sensor 1011, a pressure sensor 1012, an optical sensor 1013, and a proximity sensor 1014.

The acceleration sensor 1010 may detect acceleration on three coordinate axes of a coordinate system established by the computer device 1000. For example, the acceleration sensor 1010 may be configured to detect components of gravity acceleration on the three coordinate axes. The processor 1001 may control, according to a gravity acceleration signal acquired by the acceleration sensor 1010, the touch display screen 1005 to display the user interface in a transverse view or a longitudinal view. The acceleration sensor 1010 may be further configured to acquire motion data of a game or a user.

The gyroscope sensor 1011 may detect a body direction and a rotation angle of the computer device 1000. The gyroscope sensor 1011 may cooperate with the acceleration sensor 1010 to acquire a 3D action by the user on the computer device 1000. The processor 1001 may implement the following functions according to the data acquired by the gyroscope sensor 1011: motion sensing (such as changing the UI according to a tilt operation of the user), image stabilization at shooting, game control, and inertial navigation.

The pressure sensor 1012 may be disposed on a side frame of the computer device 1000 and/or a lower layer of the touch display screen 1005. When the pressure sensor 1012 is arranged at the side frame of the computer device 1000, a holding signal of the user on the computer device 1000 may be detected, and left/right hand identification and a quick action may be performed according to the holding signal. When the pressure sensor 1012 is arranged at the lower layer of the touch display screen 1005, an operable control on the UI interface can be controlled according to a pressure operation of the user on the touch display screen 1005. The operable control includes at least one of a button control, a scroll bar control, an icon control, and a menu control.

The optical sensor 1013 is configured to acquire ambient light intensity. In an embodiment, the processor 1001 may control display brightness of the touch display screen 1005 according to the ambient light intensity acquired by the optical sensor 1013. For example, when the ambient light intensity is relatively high, the display brightness of the touch display screen 1005 is increased. When the ambient light intensity is relatively low, the display brightness of the touch display screen 1005 is reduced. In another embodiment, the processor 1001 may further dynamically adjust a camera parameter of the camera component 1006 according to the ambient light intensity acquired by the optical sensor 1013.

The proximity sensor 1014, also referred to as a distance sensor, is generally disposed on the front surface of the computer device 1000. The proximity sensor 1014 is configured to acquire a distance between the user and the front surface of the computer device 1000. In an embodiment, when the proximity sensor 1014 detects that the distance between the user and the front surface of the computer device 1000 gradually decreases, the processor 1001 controls the touch display screen 1005 to be switched from a screen-on state to a screen-off state. When the proximity sensor 1014 detects that the distance between the user and the front surface of the computer device 1000 gradually increases, the processor 1001 controls the touch display screen 1005 to be switched from the screen-off state to the screen-on state.

A person skilled in the art may understand that the structure shown in FIG. 12 does not constitute any limitation on the computer device 1000, and the computer device may include more components or fewer components than those shown in the figure, or some components may be combined, or a different component deployment may be used.

In an exemplary embodiment, the present disclosure provides a chip, including a programmable logic circuit and/or program instructions. When the chip runs on a computer device, the chip is configured to implement the content search method provided in the foregoing method embodiments.

The present disclosure further provides a computer-readable storage medium, having a computer program stored therein, the computer program being loaded and executed by a processor to implement the content search method provided in the foregoing method embodiments.

The present disclosure provides a computer program product or a computer program, including computer instructions, the computer instructions being stored in a computer-readable storage medium. A processor of a computer device reads the computer instructions from the computer-readable storage medium, and the processor executes the computer instructions, to cause the computer device to perform the content search method provided in the foregoing method embodiments.

The technical solutions provided in the embodiments of the present disclosure include at least the following beneficial effects. As disclosed, a search term is obtained from a content input area of a first application interface, and a candidate search engine is displayed; and switching is performed from the first application interface to a second application interface in response to a selection operation on a target search engine in the candidate search engine, a search result obtained after a searching process of the search term on the target search engine being displayed on the second application interface. In the related art, when a user performs searching by switching an application, the user needs to first close a currently used first application, then start a second application that the user intends to use, and input a search term into the second application again, to obtain a search result. Compared with the related art, through use of the content search method provided in the embodiments of the present disclosure, the candidate search engine for the user to select may be directly displayed after the search term is obtained. Therefore, when the user performs searching by switching the application, the user does not need to close the currently used first application, may directly select the candidate search engine to implement switching of the application, and also does not need to repeatedly input the search term into the second application; and after the user selects the target search engine, the search result obtained through searching on the target search engine may be directly displayed on the second application interface. In this way, operations are reduced, so that efficiency of performing searching by switching the application is effectively improved, and operations are more convenient. In addition, the user can find expected content, service, commodity, and the like more quickly, and user experience can further be effectively improved.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

A person skilled in the art is to be aware that in the foregoing one or more examples, functions described in the embodiments of the present disclosure may be implemented by hardware, software, firmware, or any combination thereof. When the functions are implemented by using software, the foregoing functions may be stored in a computer-readable medium or transmitted as one or more instructions or code in a computer-readable medium. The computer-readable medium includes a computer storage medium and a communication medium, where the communication medium includes any medium that enables a computer program to be transmitted from one place to another. The storage medium may be any available medium accessible to a general-purpose or a dedicated computer.

The foregoing descriptions are merely exemplary embodiments of the present disclosure, but are not intended to limit the present disclosure. Any modification, equivalent replacement, or improvement made without departing from the spirit and principle of the present disclosure is to fall within the protection scope of the present disclosure.

What is claimed is:

1. A content search method, performed by a computer device, the method comprising:
obtaining a search term from a content input area of a first application interface, and displaying a candidate search engine; and
switching from the first application interface to a second application interface in response to a selection operation on a target search engine in the candidate search engine,
a search result, obtained after a searching process of the search term on the target search engine, being displayed on the second application interface.

2. The method according to claim 1, wherein obtaining the search term from the content input area of the first application interface comprises:
displaying an input method program based on the content input area of the first application interface; and
obtaining, through the input method program, the search term from the content input area of the first application interface.

3. The method according to claim 1, wherein an input method program comprises an intelligent search control; and the obtaining the search term from the content input area of the first application interface comprises:
obtaining, in response to a trigger operation on the intelligent search control, the search term from the content input area of the first application interface when the content input area comprises the search term.

4. The method according to claim 1, wherein an input method program comprises a first content input area and an intelligent search control; and obtaining the search term from the content input area of the first application interface comprises:
displaying, in response to a trigger operation on the intelligent search control, a second content input area when the first content input area does not comprise the search term; and
obtaining an inputted search term from the second content input area in response to a search term input operation in the second content input area.

5. The method according to claim 4, further comprising:
invoking a start input view interface;
performing a bit operation based on an attribute parameter and a constant parameter in editor information parameters of the start input view interface, to obtain an object type attribute of the content input area of the first application interface; and
determining the content input area of the first application interface as the first content input area when the object type attribute is an edit box constant.

6. The method according to claim 1, wherein an input method program comprises an intelligent search control; and obtaining the search term from the content input area of the first application interface comprises:
displaying the content input area on the first application interface in response to a trigger operation on the intelligent search control; and
obtaining an inputted search term from the content input area in response to a search term input operation in a second content input area.

7. The method according to claim 1, wherein displaying the candidate search engine comprises:
displaying a search engine list in a display area of an input method control, the search engine list comprising at least two candidate search engines,
the at least two candidate search engines comprising search engines of different sources, and the search engines of different sources corresponding to different websites or different applications; or
the at least two candidate search engines comprising search engines in different fields.

8. The method according to claim 1, wherein a second application comprises an application corresponding to the target search engine; and switching from the first application interface to the second application interface in response to the selection operation on the target search engine in the candidate search engine comprises:
in response to the selection operation on the target search engine in the candidate search engine, jumping from a first application to the application corresponding to the target search engine based on uniform resource locator information corresponding to the application of the target search engine; and
transmitting the search term to the application corresponding to the target search engine, to switch from the first application interface to the second application interface provided by the second application for displaying.

9. The method according to claim 8, wherein the second application further comprises a browser; and the method further comprises:
when the jumping is incapable of being performed from the first application to the application corresponding to the target search engine, jumping from the first application to the browser based on uniform resource locator information corresponding to the browser; and
transmitting the search term to the browser, to switch from the first application interface to the second application interface provided by the browser for displaying.

10. The method according to claim 1, wherein displaying the candidate search engine comprises:
displaying the search engine list, the search engine list comprising the candidate search engines; and
the method further comprises:
obtaining a first application identifier of the first application and a search engine distribution table, the search engine distribution table being configured for representing distribution of switching from the first application to different candidate search engines for searching by users when using the first application; and
generating the search engine list based on the first application identifier and the search engine distribution table.

11. The method according to claim 10, wherein the candidate search engines in the search engine distribution table comprise search engines of different sources, and the search engine distribution table comprises ratios of quantities of users switching from the first application to the search engines of different sources when using the first application; and generating the search engine list based on the first application identifier and the search engine distribution table comprises:
obtaining, from the search engine distribution table based on the first application identifier and the search engine distribution table, a first quantity of search engines of different sources that have largest user quantity ratios;
determining the first quantity of search engines of different sources as the candidate search engines in the search engine list when a sum of the user quantity ratios of the first quantity of search engines is greater than or equal to a ratio threshold; and
obtaining a preset first quantity of search engines in different fields when the sum of the user quantity ratios of the first quantity of search engines is less than the threshold, and determining the first quantity of search engines in different fields as the candidate search engines in the search engine list.

12. The method according to claim 10, wherein the search engine distribution table comprises a destination search engine distribution table; and the method further comprises:
obtaining usage data of seed users, the usage data being data of switching from a first sample application to different candidate sample search engines for searching by the seed users when using the first sample application, and the candidate sample search engines being a second quantity of randomly selected sample search engines; and
generating the destination search engine distribution table according to the usage data of the seed users,
the destination search engine distribution table being configured for representing distribution of switching from the first sample application to the different candidate sample search engines for searching by the seed users when using the first sample application.

13. The method according to claim 10, wherein the search engine distribution table comprises a manually configured search engine distribution table; and the method further comprises:
obtaining a first sample application identifier of a first sample application, and manually configured candidate sample search engine identifiers corresponding to the first sample application identifier; and
generating the manually configured search engine distribution table based on the first sample application identifier and the candidate sample search engine identifiers,
the manually configured search engine distribution table being configured for representing distribution of switching from the first sample application to different candidate sample search engines for searching by users when using the first sample application.

14. The method according to claim 8, further comprising:
configuring uniform resource locator information for each candidate search engine,
the uniform resource locator information being configured for pointing to a search result obtained through searching for the search term on the corresponding candidate search engine.

15. The method according to claim 14, wherein the uniform resource locator information comprises first uniform resource locator information; and
the configuring uniform resource locator information for each candidate search engine comprises:
specifying, during starting an application component of the candidate search engine, a data attribute of a runtime binding mechanism as the first uniform resource locator information of an application corresponding to the candidate search engine, setting a package attribute of the runtime binding mechanism as a candidate search engine identifier of the candidate search engine, and setting an object attribute of the runtime binding mechanism as an object view constant,
the runtime binding mechanism being configured for starting the application corresponding to the candidate search engine and opening the search result pointed to by the first uniform resource locator information.

16. The method according to claim 15, wherein the uniform resource locator information comprises second uniform resource locator information; and the method further comprises:
during starting the application component of the candidate search engine, when the specified data attribute of the runtime binding mechanism is not configured as the first uniform resource locator information, specifying the data attribute of the runtime binding mechanism as the second uniform resource locator information of a browser corresponding to the candidate search engine, and setting the object attribute of the runtime binding mechanism as the object view constant,
the runtime binding mechanism being configured for starting the browser and opening the search result pointed to by the second uniform resource locator information.

17. A computer device, comprising one or more processors and a memory containing a computer program that, when being executed, causes the one or more processors to perform:
obtaining a search term from a content input area of a first application interface, and displaying a candidate search engine; and
switching from the first application interface to a second application interface in response to a selection operation on a target search engine in the candidate search engine,
a search result, obtained after a searching process of the search term on the target search engine, being displayed on the second application interface.

18. The device according to claim 17, wherein the one or more processors are further configured to perform:
displaying an input method program based on the content input area of the first application interface; and
obtaining, through the input method program, the search term from the content input area of the first application interface.

19. The device according to claim 17, wherein an input method program comprises an intelligent search control; and the one or more processors are further configured to perform:
obtaining, in response to a trigger operation on the intelligent search control, the search term from the content input area of the first application interface when the content input area comprises the search term.

20. A non-transitory computer-readable storage medium containing a computer program that, when being executed, causes at least one processor to perform:
obtaining a search term from a content input area of a first application interface, and displaying a candidate search engine; and
switching from the first application interface to a second application interface in response to a selection operation on a target search engine in the candidate search engine,
a search result, obtained after a searching process of the search term on the target search engine, being displayed on the second application interface.
